(19) United States
(12) Patent Application Publication
(10) Pub. No.: US 2023/0344571 A1
(43) Pub. Date: Oct. 26, 2023

(54) COMMUNICATION APPARATUS AND COMMUNICATION METHOD FOR MULTI-USER MULTIPLE INPUT MULTIPLE OUTPUT TRANSMISSIONS

(71) Applicant: Panasonic Intellectual Property Corporation of America, Torrance, CA (US)

(72) Inventors: Lei HUANG, Singapore (SG); Yoshio URABE, Nara (JP); Rojan CHITRAKAR, Singapore (SG)

(21) Appl. No.: 18/001,701

(22) PCT Filed: May 11, 2021
(86) PCT No.: PCT/SG2021/050258

§ 371 Date: Dec. 13, 2022

(30) Foreign Application Priority Data
Jun. 15, 2020 (SG) 10202005664S

(51) Int. Cl. H04B 7/0452; H04L 5/00

(52) U.S. Cl. CPC H04L 5/0044; H04B 7/0452; H04W 84/12

(57) ABSTRACT

The present disclosure provides communication apparatus and communication method for multi-user multiple input multiple output transmissions. The communication apparatus comprises: circuitry, which, in operation, generates a physical layer protocol data unit (PPDU) comprising a signal field that indicates resource unit (RU) assignment information for a plurality of other communication apparatuses; and a transmitter, which, in operation, transmits the PPDU to the plurality of other communication apparatuses in two or more 80 MHz frequency segments; wherein when one of the plurality of other communication apparatuses parks in one of the two or more 80 MHz frequency segments, RU assignment information corresponding to the one of the plurality of other communication apparatuses is indicated in the signal field transmitted in the one of the two or more 80 MHz frequency segments.

### TECHNICAL FIELD

The present disclosure relates to communication apparatuses and methods for multiple input multiple output (MIMO) transmissions, and more particularly to communication apparatuses and methods for multi-user multiple input multiple output (MU-MIMO) transmissions in extremely high throughput wireless local area network (EHT WLAN).

### BACKGROUND

In the standardization of next generation wireless local area network (WLAN), a new radio access technology having backward compatibilities with IEEE 802.11a/b/g/n/ac/ax technologies has been discussed in the IEEE 802.11 Working Group and is named IEEE 802.11be Extremely High Throughput (EHT) WLAN.

In 802.11be EHT WLAN, in order to improve spectral efficiency and provide significant peak throughput and capacity increase over 802.11ax high efficiency (HE) WLAN, it has been proposed to increase maximum channel bandwidth to 320 MHz and maximum number of spatial streams from 8 to 16.

However, there has been no much discussion on communication apparatuses and methods on efficient MU-MIMO transmission in an EHT PPDU having a bandwidth up to 320 MHz.

There is thus a need for communication apparatuses and methods that provide feasible technical solutions for MU-MIMO in the context of EHT WLAN. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for MU-MIMO transmissions in context of EHT WLAN.

According to an embodiment of the present disclosure, there is provided a communication apparatus comprising: circuitry, which, in operation, generates a physical layer protocol data unit (PPDU) comprising a signal field that indicates resource unit (RU) assignment information for a plurality of other communication apparatuses; and a transmitter, which, in operation, transmits the PPDU to the plurality of other communication apparatuses in two or more 80 MHz frequency segments; wherein when one of the plurality of other communication apparatuses parks in one of the two or more 80 MHz frequency segments, RU assignment information corresponding to the one of the plurality of other communication apparatuses is indicated in the signal field transmitted in the one of the two or more 80 MHz frequency segments.

According to another embodiment of the present disclosure, there is provided a communication apparatus comprising: a receiver, which, in operation, receives a physical layer protocol data unit (PPDU) comprising a signal field that indicates resource unit (RU) assignment information for the communication apparatus transmitted in two or more 80 MHz frequency segments; and circuitry, which, in operation, processes the PPDU, wherein when the communication apparatus parks in one of the two or more 80 MHz frequency segments, RU assignment information corresponding to the communication apparatuses is indicated in the signal field transmitted in the one of the two or more 80 MHz frequency segments

According to yet another embodiment of the present disclosure, there is provided a communication method comprising: generating a physical layer protocol data unit (PPDU) comprising a signal field that indicates resource unit (RU) assignment information for a plurality of other communication apparatuses; and transmitting the PPDU to the plurality of other communication apparatuses in two or more 80 MHz frequency segments; wherein when one of the plurality of other communication apparatuses parks in one of the two or more 80 MHz frequency segments, RU assignment information corresponding to the one of the plurality of other communication apparatuses is indicated in the signal field transmitted in the one of the two or more 80 MHz frequency segments.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1A depicts a schematic diagram of uplink and downlink single-user (SU) multiple input multiple output (MIMO) communication between an access point (AP) and a station (STA) in a MIMO wireless network.

FIG. 1B depicts a schematic diagram of downlink multi-user (MU) communication between an AP and multiple STAs in a MIMO wireless network.

FIG. 1C depicts a schematic diagram of trigger-based uplink MU communication between an AP and multiple STAs in a MIMO wireless network.

FIG. 1D depicts a schematic diagram of trigger-based downlink multi-AP communication between multiple APs and a STA in a MIMO wireless network.

FIG. 1E depicts a format of a PPDU (physical layer protocol data unit (used for downlink multi-user (MU) communications between an AP and multiple STAs in an HE WLAN.

FIG. 1F depicts the HE-SIG-B (HE Signal B) field in more detail.

FIG. 2A depicts an example format of an EHT basic PPDU.

FIG. 2B depicts pre-EHT modulated fields of an EHT basic PPDU with a bandwidth of 320 MHz according to an embodiment.

FIG. 3 depicts an example format of EHT-SIG content channel.

FIGS. 4A and 4B depict example formats of common field of EHT-SIG field of an EHT basic PPDU with a bandwidth of 320 MHz.

FIGS. 5A and 5B depict example formats of common field of EHT-SIG field of an EHT basic PPDU with a bandwidth of 320 MHz.

FIG. 6 shows a schematic example of communication apparatus in accordance with various embodiments. The communication apparatus may be implemented as an AP or a STA and configured for MU-MIMO transmissions in accordance with the present disclosure.

FIG. 7 shows a flow diagram illustrating a communication method according to the present disclosure.

FIG. 8 depicts example RU assignments under a bandwidth of 320 MHz according to an embodiment.

FIG. 9 shows a configuration of a communication device, for example an AP according to the present disclosure.

FIG. 10 shows a configuration of a communication device, for example an STA, according to the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for uplink or downlink control signaling, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N × M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

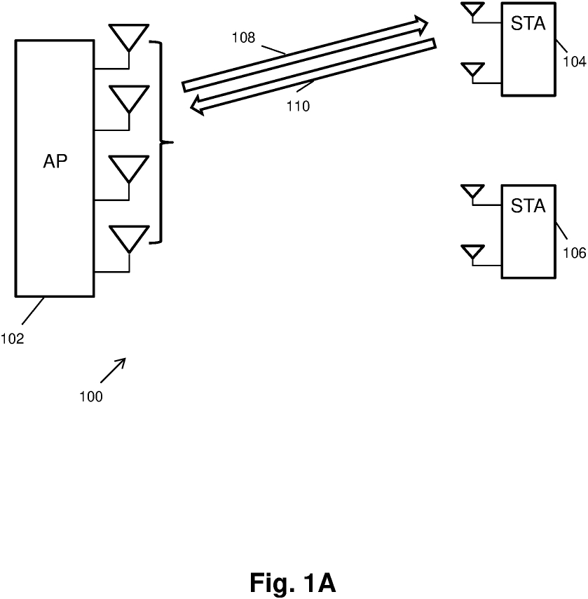

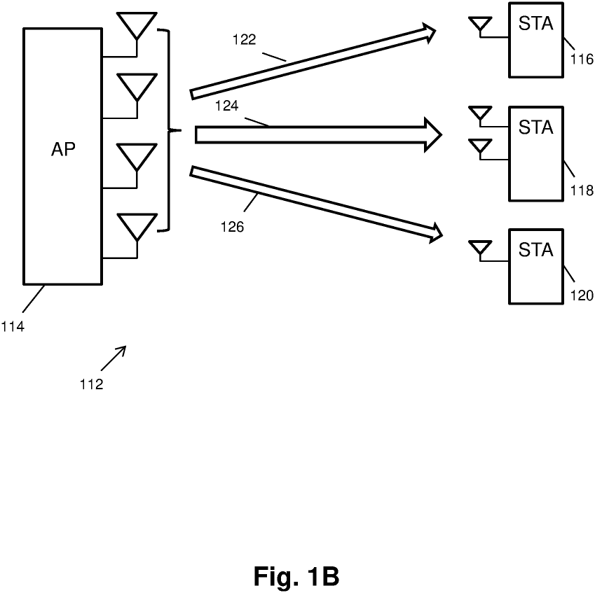

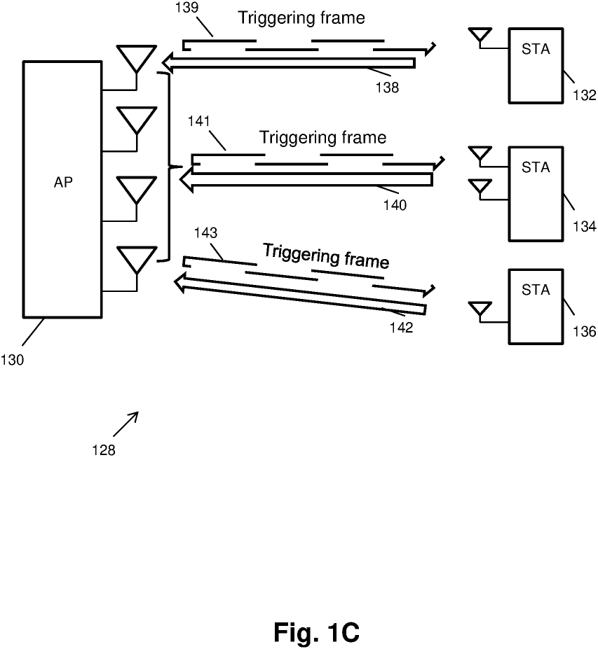

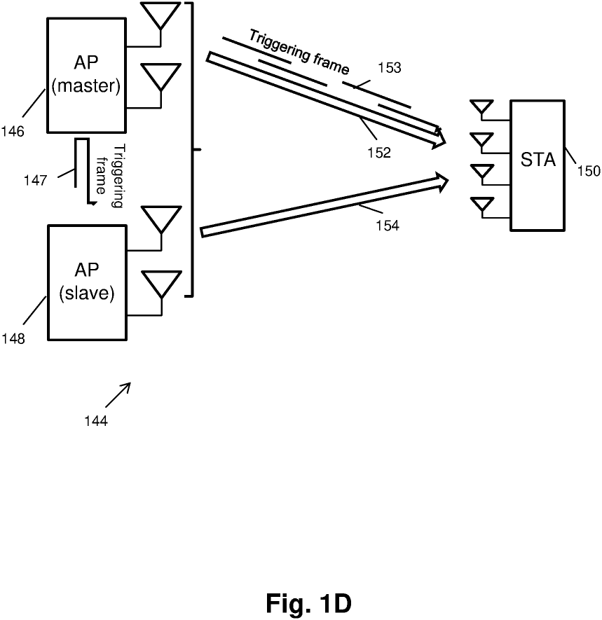

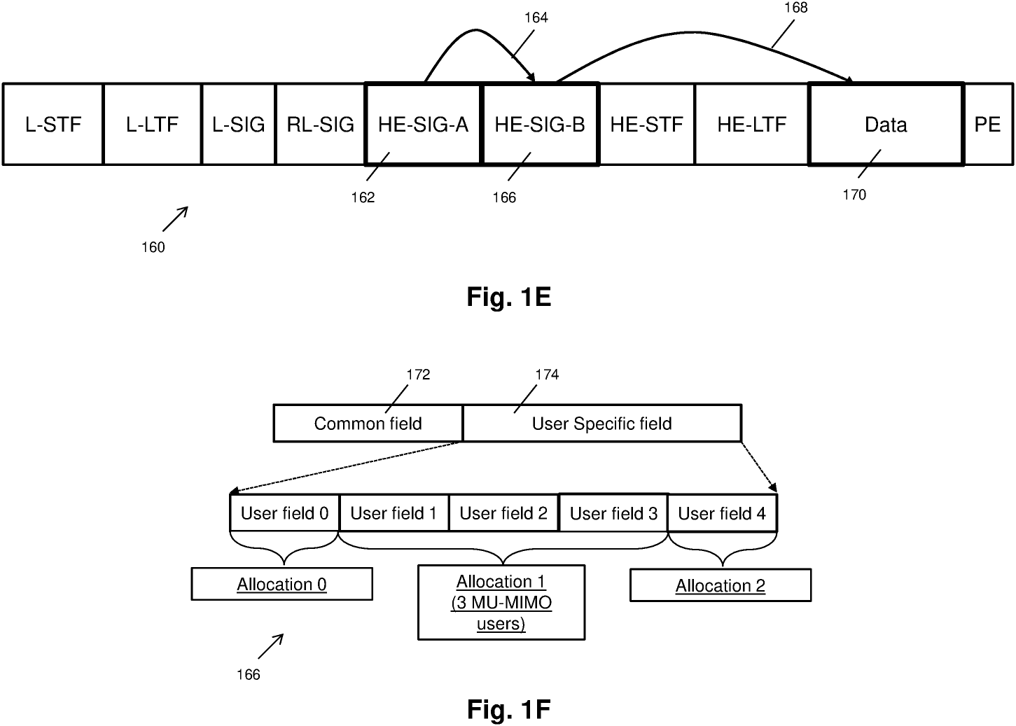

FIG. 1A depicts a schematic diagram of SU communication 100 between an AP 102 and a STA 104 in a MIMO wireless network. As shown, the MIMO wireless network may include one or more STAs (e.g. STA 104, STA 106, etc.). If the SU communication 100 in a channel is carried out over whole channel bandwidth, it is called full bandwidth SU communication. If the SU communication 100 in a channel is carried out over a part of the channel bandwidth (e.g. one or more 20 MHz subchannels within the channel is punctured), it is called punctured SU communication. In the SU communication 100, the AP 102 transmits multiple space-time streams using multiple antennas (e.g. four antennas as shown in FIG. 1A) with all the space-time streams directed to a single communication apparatus, i.e. the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1A, in the SU communication 100, the STA 104 may transmit multiple space-time streams using multiple antennas (e.g. two antennas as shown in FIG. 1A) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1A enables both uplink and downlink SU transmissions in a MIMO wireless network.

FIG. 1B depicts a schematic diagram of downlink MU communication 112 between an AP 114 and multiple STAs 116, 118, 120 in a MIMO wireless network. The MIMO wireless network may include one or more STAs (e.g. STA 116, STA 118, STA 120, etc.). The MU communication 112 can be an OFDMA (orthogonal frequency division multiple access) communications or a MU-MIMO communication. For an OFDMA communication in a channel, the AP 114 transmits multiple streams simultaneously to the STAs 116, 118, 120 in the network at different resource units (RUs) within the channel bandwidth. For a MU-MIMO communication in a channel, the AP 114 transmits multiple streams simultaneously to the STAs 116, 118, 120 at same RU(s) within the channel bandwidth using multiple antennas via spatial mapping or precoding techniques. If the RU(s) at which the OFDMA or MU-MIMO communication occurs occupy whole channel bandwidth, the OFDMA or MU-MIMO communications is called full bandwidth OFDMA or MU-MIMO communications. If the RU(s) at which the OFDMA or MU-MIMO communication occurs occupy a part of channel bandwidth (e.g. one or more 20 MHz subchannel within the channel is punctured), the OFDMA or MU-MIMO communication is called punctured OFDMA or MU-MIMO communications. For example, two space-time streams may be directed to the STA 118, another space-time stream may be directed to the STA 116, and yet another space-time stream may be directed to the STA 120. For the sake of simplicity, the two space-time streams directed to the STA 118 are illustrated as a grouped data transmission arrow 124, the space-time stream directed to the STA 116 is illustrated as a data transmission arrow 122, and the space-time stream directed to the STA 120 is illustrated as a data transmission arrow 126.

To enable uplink MU transmissions, trigger-based communication is provided to the MIMO wireless network. In this regard, FIG. 1C depicts a schematic diagram of trigger-based uplink MU communication 128 between an AP 130 and multiple STAs 132, 134, 136 in a MIMO wireless network.

Since there are multiple STAs 132, 134, 136 participating in the trigger-based uplink MU communication, the AP 130 needs to coordinate simultaneous transmissions of multiple STAs 132, 134, 136.

To do so, as shown in FIG. 1C, the AP 130 transmits triggering frames 139, 141, 143 simultaneously to STAs 132, 134, 136 to indicate user-specific resource allocation information (e.g. the number of space-time streams, a starting STS number and the allocated RUs) each STA can use. In response to the triggering frames, STAs 132, 134, 136 may then transmit their respective space-time streams simultaneously to the AP 130 according to the user-specific resource allocation information indicated in the triggering frames 139, 141, 143. For example, two space-time streams may be directed to the AP 130 from STA 134, another space-time stream may be directed to the AP 130 from STA 132, and yet another space-time stream may be directed to the AP 130 from STA 136. For the sake of simplicity, the two space-time streams directed to the AP 130 from STA 134 are illustrated as a grouped data transmission arrow 140, the space-time stream directed to the AP 130 from STA 132 is illustrated as a data transmission arrow 138, and the space-time stream directed to the AP 130 from STA 136 is illustrated as a data transmission arrow 142.

Trigger-based communication is also provided to the MIMO wireless network to enable downlink multi-AP communication. In this regard, FIG. 1D depicts a schematic diagram of downlink multi-AP communication 144, between a STA 150 and multiple APs 146, 148 in a MIMO wireless network.

Since there are multiple APs 146, 148 participating in the trigger-based downlink multi-AP MIMO communication, the master AP 146 needs to coordinate simultaneous transmissions of multiple APs 146, 148.

To do so, as shown in FIG. 1D, the master AP 146 transmits triggering frames 147, 153 simultaneously to the AP 148 and the STA 150 to indicate AP-specific resource allocation information (e.g. the number of space-time streams, a starting STS stream number and the allocated RUs) each AP can use. In response to the triggering frames, the multiple APs 146, 148 may then transmit respective space-time streams to the STA 150 according to the AP-specific resource allocation information indicated in the triggering frame 147; and the STA 150 may then receive all the space-time streams according to the AP-specific resource allocation information indicated in the triggering frame 153. For example, two space-time streams may be directed to the STA 150 from AP 146, and another two space-time streams may be directed to the STA 150 from AP 148. For the sake of simplicity, the two space-time streams directed to the STA 150 from AP 146 are illustrated as a grouped data transmission arrow 152, and the two space-time streams directed to the STA 150 from the AP 148 is illustrated as a grouped data transmission arrow 154.

Due to packet/PPDU (physical layer protocol data unit) based transmission and distributed MAC (medium access control) scheme in 802.11 WLAN, time scheduling (e.g. TDMA (time division multiple access)-like periodic time slot assignment for data transmission) does not exist in 802.11 WLAN. Frequency and spatial resource scheduling is performed on a packet basis. In other words, resource allocation information is on a PPDU basis.

FIG. 1E shows a format of a PPDU 160 used for downlink MU communications between an AP and multiple STAs in a HE WLAN, e.g. OFDMA (Orthogonal Frequency Division Multiple Access) transmission including MU-MIMO transmission in a single RU and full-bandwidth MU-MIMO transmission. Such a PPDU 160 is referred to as an HE MU PPDU 160. The HE MU PPDU 160 may include a non-High Throughput Short Training Field (L-STF), a non-High Throughput Long Training Field (L-LTF), a non-High Throughput SIGNAL (L-SIG) field, a Repeated L-SIG (RL-SIG) field, a HE SIGNAL A (HE-SIG-A) field 162, a HE SIGNAL B (HE-SIG-B) field 166, a HE Short Training Field (HE-STF), a HE Long Training Field (HE-LTF), a Data field 170 and a Packet Extension (PE) field. In the HE MU PPDU 160, the HE-SIG-B field 166 provides the OFDMA and MU-MIMO resource allocation information to allow STAs to look up the corresponding resources to be used in the Data field 160, like indicated by an arrow 168. The HE-SIG-A field 162 contains the necessary information for decoding the HE-SIG-B field 166, e.g. modulation and coding scheme (MCS) for HE-SIG-B, number of HE-SIG-B symbols, like indicated by an arrow 164.

FIG. 1F depicts the HE-SIG-B field 166 in more detail. The HE-SIG-B field 166 includes (or consists of) a Common field 172, if present, followed by a User Specific field 174 which together are referred to as the HE-SIG-B content channel. The HE-SIG-B field 166 contains a RU Allocation subfield which indicates the RU information for each of the allocations. The RU information includes a RU position in the frequency domain, an indication of the RU allocated for a non-MU-MIMO or MU-MIMO allocation, and the number of users in the MU-MIMO allocation. The Common field 172 is not present in the case of a full-bandwidth MU-MIMO transmission. In this case, the RU information (e.g. the number of users in the MU-MIMO allocation) is signalled in the HE-SIG-A field 162.

The User Specific field 174 includes (or consists of) one or more user field(s) for non-MU-MIMO allocation(s) and/or MU-MIMO allocation(s). A user field contains user information indicating a user-specific allocation (i.e. user-specific allocation information). In the example shown in FIG. 1F, the User Specific field 174 includes five user fields (User field 0, ..., User field 4), wherein user-specific allocation information for an allocation (Allocation 0) is provided by User field 0, user-specific allocation information for a further allocation (Allocation 1 with 3 MU-MIMO users) is provided by User field 1, User field 2, and User field 3, and user-specific allocation information for yet a further allocation (Allocation 2) is provided by User field 4.

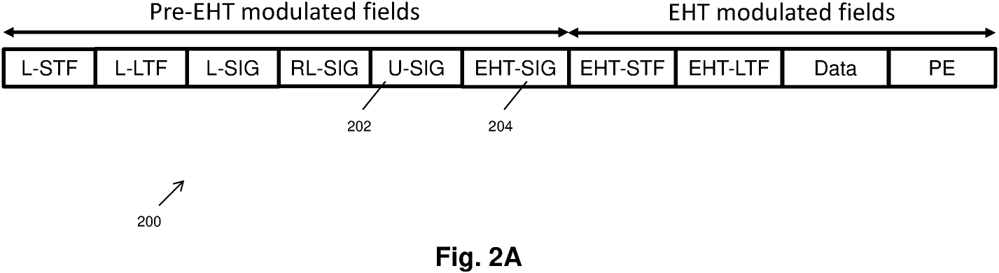

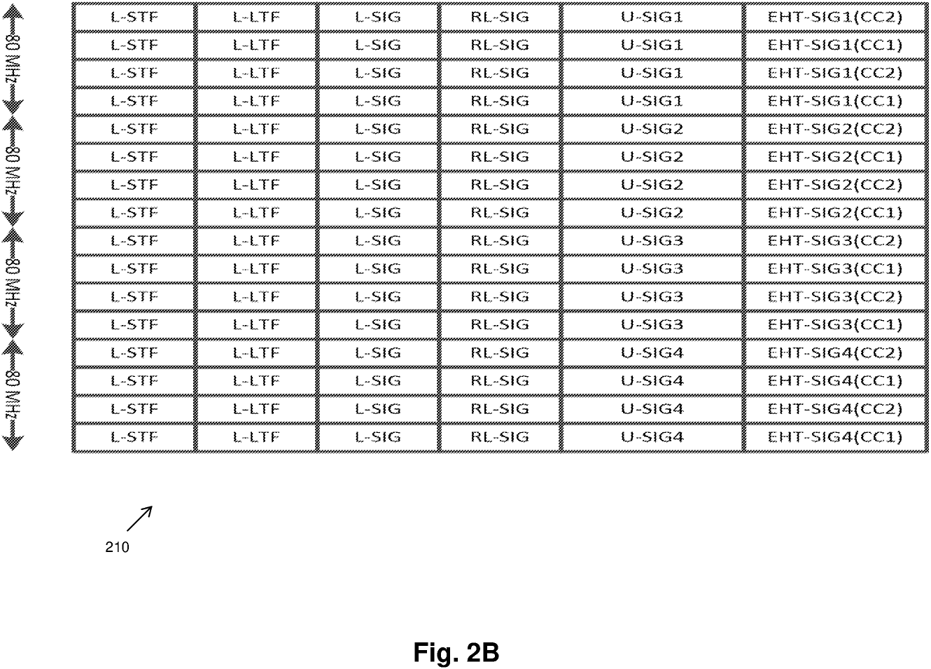

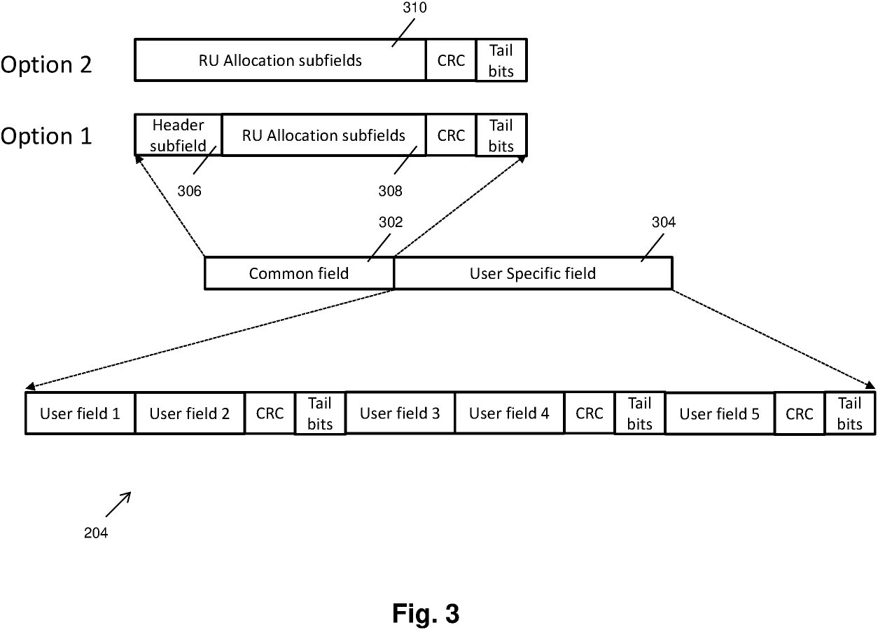

If the MIMO wireless network is with an extremely high throughput, such as an 802.11be EHT WLAN, the PPDU used for downlink MU transmission, downlink SU transmission or uplink SU transmission may be referred to as EHT basic PPDU 200 like illustrated in FIG. 2A.

According to various embodiments, EHT WLAN supports non-trigger-based communications as illustrated in FIG. 1A and FIG. 1B. In non-trigger-based communications, a communication apparatus transmits a PPDU to one other communication apparatus or more than one other communication apparatuses in an unsolicited manner.

FIG. 2A depicts an example format of an EHT basic PPDU 200, which can be used for non-trigger-based communications. The EHT basic PPDU 200 may include a L-STF, a L-LTF, a L-SIG field, a RL-SIG field 201, a Universal SIGNAL (U-SIG) field 202, an EHT SIGNAL (EHT-SIG) field 204, an EHT-STF, an EHT-LTF, a Data field 210 and a PE field. The L-STF, the L-LTF, the L-SIG field, the RL-SIG field, the U-SIG field and the EHT-SIG field may be grouped as pre-EHT modulated fields, while the EHT-STF, the EHT-LTF, the Data field and the PE field may be grouped as EHT modulated fields. Both U-SIG field 202 and EHT-SIG field 204 are present in the EHT basic PPDU 200 transmitted to a single STA or multiple STAs. It is appreciable that if the IEEE 802.11 Working Group may use a new name instead of “EHT WLAN” for the next generation WLAN with an extremely high throughput, the prefix “EHT” in the above fields may change accordingly. The RL-SIG field 201 is mainly used for identifying any PHY versions starting with 802.11be. The U-SIG field 202 contains the necessary information for decoding the EHT-SIG field 204, e.g. MCS for EHT-SIG, number of EHT-SIG symbols, like indicated by an arrow 204. The U-SIG field 202 and the EHT-SIG field 204 provide necessary information for decoding the Data field 210, like indicated by arrows 207, 208 respectively. When the EHT basic PPDU 200 is transmitted to multiple STAs, the EHT-SIG field 204 provides the OFDMA and MU-MIMO resource allocation information to allow STAs to look up the corresponding resources to be used in the Data field 210.

According to various embodiments, the U-SIG field 202 has a duration of two orthogonal frequency-division multiplexing (OFDM) symbols. Data bits in the U-SIG field 202 are jointly encoded and modulated in the same manner as the HE-SIG-A field of 802.11ax. Modulated data bits in the U-SIG field 202 are mapped to 52 data tones of each of the two OFDM symbols and duplicated for each 20 MHz within each 80 MHz frequency segment in the same manner as the HE-SIG-A field of 802.11ax. The U-SIG field 202 may carry different information for each of 80 MHz frequency segments. According to various embodiments, the term “frequency segment” may be used interchangeably with the term “subchannel”. A frequency segment may also be referred to as a frequency subblock.

In various embodiments, the U-SIG field 202 may comprise two parts: U-SIG field 1 and U-SIG field 2, each comprising 26 data bits. The U-SIG field 202 comprises all version independent bits and a part of version dependent bits. All version independent bits are included in U-SIG field 1 and have static location and bit definition across different physical layer (PHY) versions, the version independent bits comprising PHY version identifier (3 bits), bandwidth (BW) field (3 bits), uplink/downlink (UL/DL) flag (1 bit), basic service set (BSS) color (e.g. 6 bits) and transmission opportunity (TXOP) duration (e.g. 7 bits). The PHY version identifier of the version independent bits is used to identify the exact PHY version starting with 802.11be, and the BW field is used to indicate PPDU bandwidth. The effect of including all version-independent bits into one part of the U-SIG field 202, i.e. U-SIG field 1, is that the legacy STAs only require to parse the U-SIG field 1 and thus their power efficiency can be improved. On the other hand, version dependent bits may have variable bit definition in each PHY version. The part of version dependent bits included in the U-SIG field 202 may comprise PPDU format, punctured channel information, pre-FEC padding factor, PE disambiguity and EHT-SIG related bits which are used for interpreting EHT-SIG field 204, and spatial reuse related bits which are used for coexisting with unintended STAs.

The EHT-SIG field 204 of EHT basic PPDU 200 may include remaining version dependent bits. It has a variable MCS and variable length. EHT-SIG field 504 has a Common field followed by a User Specific field which together are referred to as an EHT-SIG content channel. The User Specific field comprises one or more user field. The Common field may comprise one or more RU allocation subfield indicating RU assignment information for one or more STAs. The EHT-SIG field may vary on each 80 MHz frequency segment.

FIG. 2B depicts the pre-EHT modulated fields of the ETH basic PPDU 200 in a 320 MHz BW according to an embodiment. A 320 MHz BW comprising four 80 MHz frequency segments and sixteen 20 MHz frequency segments (each 80 MHz frequency segment has four 20 MHz frequency segments). The U-SIG field 202 may carry different information for each of four 80 MHz frequency segments. In other words, U-SIG1 field, U-SIG2 field, U-SIG3 field and U-SIG4 field may be transmitted in the four 80 MHz frequency segments respectively. The EHT-SIG field 204 may vary in each of four 80 MHz frequency segments. In other words, EHT-SIG1 field, EHT-SIG2 field, EHT-SIG3 field and EHT-SIG4 field may be transmitted in the four 80 MHz frequency segments respectively. Further, the EHT-SIG field 204 in each 80 MHz frequency segment comprises two EHT-SIG content channels (CC1 and CC2), each of the two EHT-SIG content channels is duplicated in every other 20 MHz subchannel within the 80 MHz frequency segment, as shown in FIG. 2B.

FIG. 3 depicts an example EHT-SIG content channel 300 comprising a Common field 302 and a User Specific field 304. In an embodiment, a User Specific field 304 may consist of one or more User Block field(s), and each User Block field comprises one or two user fields. In this embodiment, the User Block field 1 comprising two user fields like User field 1 and User field 2, User Block field 2 comprising two user fields like User field 3 and User field 4, and User Block field 3 comprising one User field 5, where the one or two user fields in each of User Block fields 1 to 3 is appended with a CRC field for detecting error and tail bits. In an embodiment, the last User Block may consist of one or two user fields depending on the total number of user fields that are allowed in the User Specific field referring to an odd or even number.

According to various embodiments, the User Specific field may comprise a plurality of user fields, such as user fields 1-5, each of which contains transmission parameters corresponding to a STA assigned with a corresponding RU or RU combination. For a RU or RU combination allocated for a non-MU-MIMO transmission, there is a single corresponding user field; and for a RU or RU combination allocated for MU-MIMO transmission with N user, there are N corresponding user fields.

According to the present disclosure, there are two options for the Common field 302 of the EHT-SIG field 204, i.e. Option 1 and Option 2. Regarding Option 1 of Common field, the Common field 302 may comprise a Header subfield 306 and one or more RU Allocation subfield 308 followed by a CRC field and tail bits. The number of bits in the Header subfield 306 can be dependent on the BW. For example, the Header subfield 306 may not be present in a 20 MHz, 40 MHz or 80 MHz BW PPDU and the Header subfield 306 may have 8 bits for 160 MHz BW PPDU, 12 bits for 240 MHz BW PPDU or 16 bits for 320 MHz BW PPDU. In various embodiments, the position of bit “1” in the Header subfield 306 indicates the starting of the RU assignment(s) specified by each RU Allocation subfield, and the total number of “1” bits in the Header subfield 306 then represents the total number of RU Allocation subfields in the Common field 302. The Header subfield values in each 80 MHz frequency segment can be different, thus advantageously allowing flexible indication of RU in any place and efficient signalling.

A RU Allocation subfield 308 indicates one or more RU assignment, including the size of the RU(s) or RU combination(s) and their placement in the frequency domain, to be used in the EHT modulated fields of the EHT basic PPDU 200 and indicates information needed to compute the number of users allocated to each RU or RU combination. The number of RU Allocation subfields, N, may vary in each 80 MHz frequency segment or each content channel.

In various embodiments of the present disclosure, a STA parks in an 80 MHz frequency segment called listening 80 MHz frequency segment (L80). A STA’s L80 may be primary 80 MHz (P80) by default, or a STA’s L80 may be an 80 MHz frequency segment other than P80 through a negotiation procedure between the STA and AP. When a STA parks in an 80 MHz subchannel which is not the primary 80 MHz, the operation with such a STA may be referred to as subchannel selective transmission (SST) operation. RU assignment information for a STA shall be completely indicated in EHT-SIG field transmitted in the STA’s L80, the effect of which is the STA only needs to process the pre-EHT modulated fields transmitted in the STA’s L80 to obtain all of its RU assignment information, and power consumption of the STA may be reduced.

In an embodiment, in an 80 MHz frequency segment where compression mode is enabled, there is no Header subfield and RU Allocation subfields in the Common field. Such compression mode in an 80 MHz frequency segment can be enabled if all STA(s) parking in the 80 MHz frequency segment engage in a non-OFDMA transmission. A non-OFDMA transmission refers to a MU-MIMO transmission or a SU transmission.

According to various embodiments, a MU-MIMO allocation for a RU or RU combination in an EHT basic PPDU has a maximum number of spatial streams of 16, a maximum number of users of 8 (i.e. Nᵤₛₑᵣ ≤ 8), a maximum number of spatial streams per user of 4 and a minimum RU size to support MU-MIMO is 242-tone RU. More than one RUs are allowed to be allocated to a single STA in an EHT basic PPDU. In various embodiments, where RUs with sizes equal to or more than 242 tones are defined as large-size RUs and RUs with size less than 242 tones are defined as small-size RUs, allowed small-size RU combinations may include (i) two adjacent 26-tone RU (RU26) and 52-tone RU (RU52) within a 20 MHz subchannel; and (ii) two adjacent RU26 and 106-tone RU (RU106) within a 20 MHz subchannel; whereas allowed large-size RU combinations may include (i) one 242-tone RU (RU242) and one 484-tone RU (RU484) within an 80 MHz frequency segment, (ii) one RU484 and one 996-tone RU (RU996) within a 160 MHz frequency segment, and (iii) three RU996 in a 320 MHz channel. Tables 4-6 show values of the RU Allocation subfield 308 signaling assignments of small-size RUs, small-size RU combinations, large-size RUs, and large-size RU combinations respectively according to an embodiment.

In the embodiment, according to tables 4-6, #1 to #9 (from left to right of the tables) is ordered in increasing order of the absolute frequency. Among RU Allocation subfield values of 32-54, a 78-tone RU (RU78) and a 132-tone RU (RU132) refers to the two allowed small-size RU combinations of two adjacent RU26 and RU52 and two adjacent RU26 and RU106 within a 20 MHz subchannel respectively. For signaling RUs or RU combination of size is greater than 242 tones, letter y₂y₁y₀, or the last three digits of the binary vector, of the RU Allocation subfield value may indicate the number of user fields in the EHT-SIG content channel that contains the corresponding RU Allocation subfield. Otherwise, the binary vector y₂y₁y₀, indicates the number of users multiplexed in the 242-tone RU. In an embodiment, the number of user, Nᵤₛₑᵣ(r), multiplexed in the RU r or RU combination r can be calculated based on the following equation:

$${N}_{\text{user}} \left(r\right) = 4 \times {y}_{2} + 2 \times {y}_{1} + {y}_{0} + 1 \qquad \text{equation (1)}$$

In other words, for a large-size RU r or a large-size RU combination r, if the letter y₂y₁y₀, are present in the RU Allocation subfield, the Nᵤₛₑᵣ(r) is indicated by the letter; if the letter y₂y₁y₀, is not present, Nᵤₛₑᵣ(r) is 0. For a small-size RU r or a small-size RU combination r, the number of user field Nᵤₛₑᵣ(r) is 1. In an embodiment, “-” in the tables 4-6 means no user is assigned with that RU, i.e. Nᵤₛₑᵣ(r) = 0.

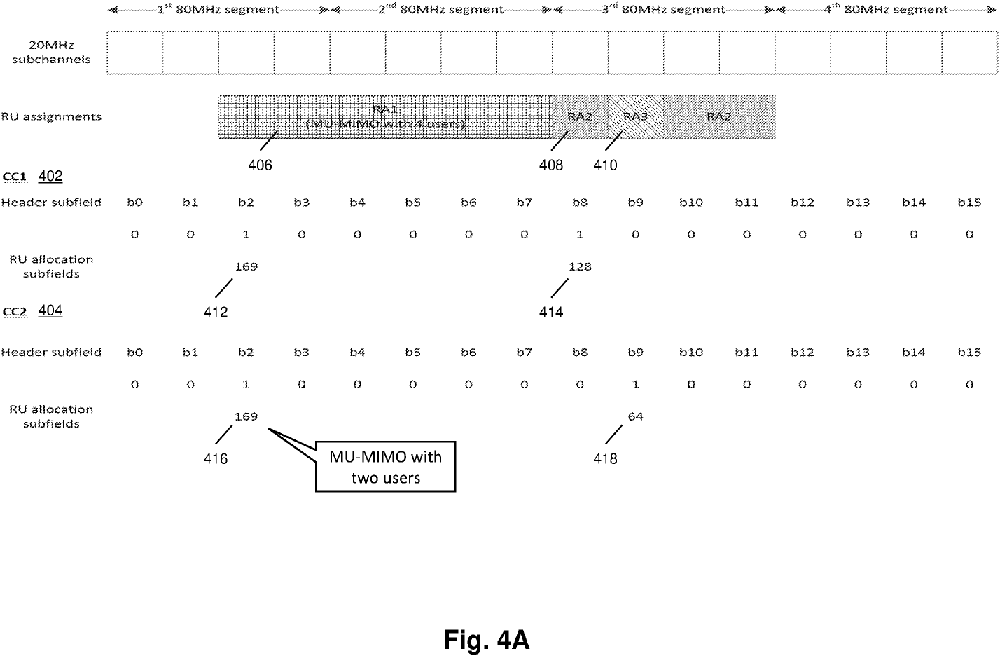

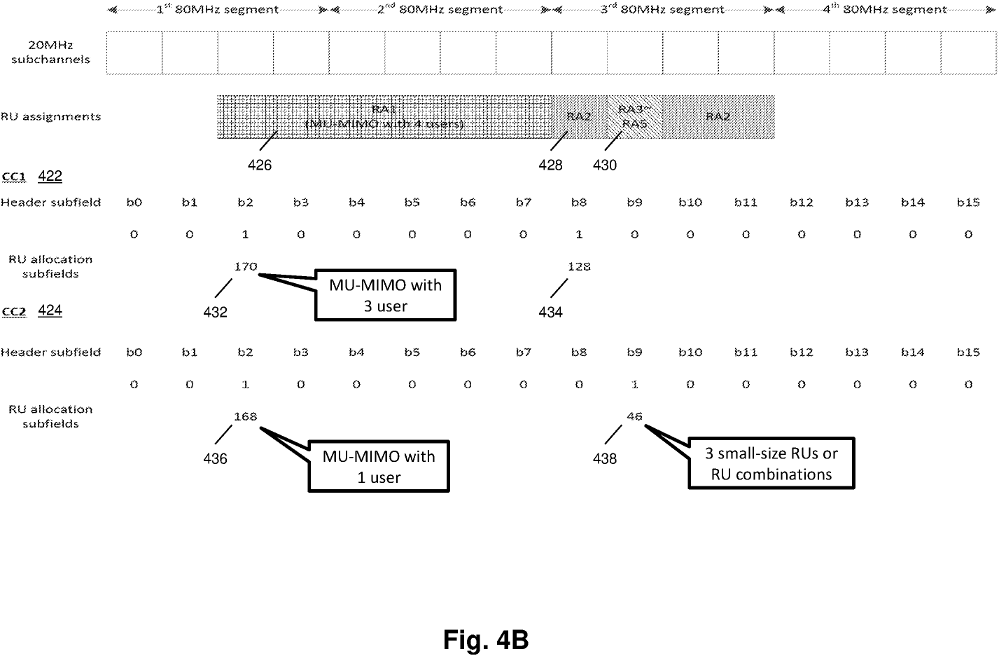

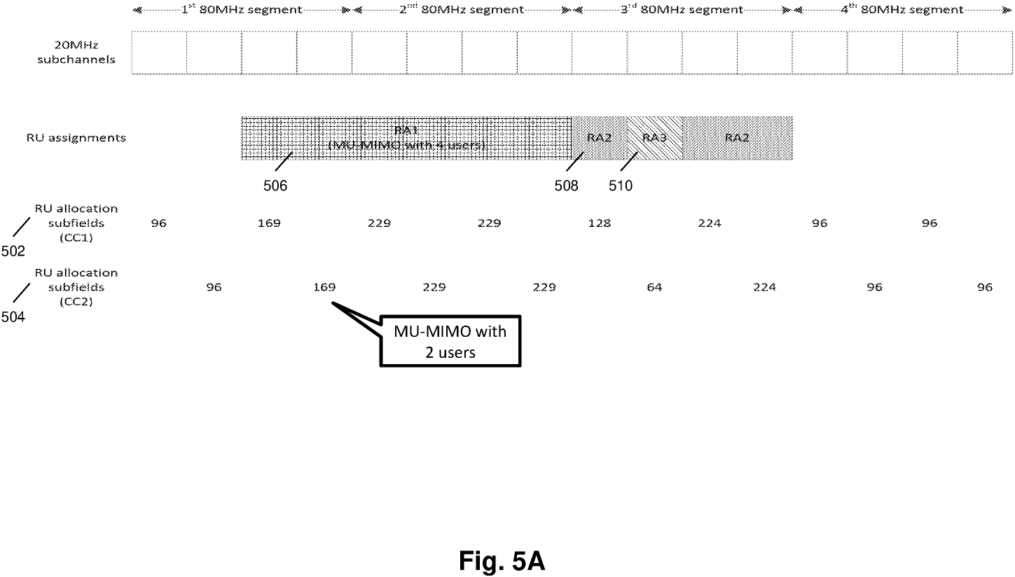

FIG. 4A depicts example common fields of EHT-SIG content channels 1 (CC1) 402 and EHT-SIG content channel 2 (CC2) 404 transmitted in an 80 MHz frequency segment used for signalling large-size RU assignments and large-size RU combination assignments in a 320 MHz BW PPDU. In this example, three RUs or RU combinations are assigned, in particular: (i) a large-size RU allocation (RA1) 406 in 1^{st} and 2^{nd} 80 MHz frequency segments for a MU-MIMO transmission with four users, (ii) a large-size RU combination allocation (RA2) 408 in 3^{rd} 80 MHz frequency segment for a non-MU-MIMO transmission, and (iii) a large-size RU allocation (RA3) 410 in 2^{nd} 20 MHz subchannel of 3^{rd} 80 MHz frequency segment for a non-MU-MIMO transmission. For a 320 MHz BW PPDU, each of CC1 and CC2 transmitted in the 80 MHz frequency segment comprises a Header subfield with 16 bits b0-b15 and one or more RU Allocation subfield to indicate RU assignment information. Bit “1” position in the Header subfield indicates the starting point of RU assignment(s) specified by each RU Allocation subfield, and a RU Allocation subfield indicates one or more RU assignment, including the size of the RU(s) or RU combination(s) and their placement in the frequency domain, used in the EHT modulated fields of the 320 MHz BW PPDU.

In CC1 402, bit “1” is positioned at b2 and b8 of its Header subfield, indicating the number of RU Allocation subfields in CC1 402 is two and RU assignments specified by the two RU Allocation subfields 412, 414 start at the 3^{rd} 20 MHz subchannel of the 1^{st} 80 MHz frequency segment and the 1^{st} 20 MHz subchannel of the 3^{rd} 80 MHz frequency segment respectively. In accordance with the tables 4-6, the first RU Allocation subfield 412 of CC1 402 has a value of 169 indicating assignments of a RU combination of a 484-tone RU and a 996-tone RU in a 160 MHz frequency segment contributing two user fields to the User Specific field of CC1 402; and the second RU Allocation subfield 414 of CC1 402 has a value of 128 indicating an assignment of a RU combination of a 242-tone RU and a 484-tone RU in an 80 MHz frequency segment contributing one user field to the User Specific field in CC1 402.

On the other hand, in CC2 404, bit″1″ is positioned at b2 and b9 of the header subfield, indicating the number of RU Allocation subfields is two and RU assignments specified by the two RU Allocation subfields 416, 418 start at the 3^{rd} 20 MHz subchannel of the 1^{st} 80 MHz frequency segment and the 2^{nd} 20 MHz subchannel of the 3^{rd} 80 MHz frequency segment respectively. Similar to that in CC1, the first RU Allocation subfield 416 of CC2 404 has a value of 169 indicating assignments of a RU combination of a 484-tone RU and a 996-tone RU in a 160 MHz frequency segment contributing two user fields to the User Specific field of CC2 404, and the second RU Allocation subfield 418 of CC2 404 has a value of 64 indicating a single RU assignment contributing a user field to the User Specific field of CC2 404. It is noted that each of CC1 402 and CC2 404 has three user fields in the User Specific field for load balancing purpose.

FIG. 4B depicts example common fields of EHT-SIG CC1 422 and CC2 424 transmitted in an 80 MHz frequency segment used for signalling a mix of small-size RU or RU combination assignments and large-size RU or RU combination assignments in a 320 MHz BW PPDU. In this example, five RUs or RU combinations are assigned, in particular: (i) a large-size RU allocation (RA1) 426 for a MU-MIMO transmission with 4 users in 1^{st} and 2^{nd} 80 MHz frequency segments, (ii) a large-size RU allocation (RA2) 428 in 3^{rd} 80 MHz frequency segment and (iii) three small-size RU or RU combination allocations (RA3-RA5) 430 in 2^{nd} 20 MHz subchannel of 3^{rd} 80 MHz frequency segment.

In CC1 422, bit “1” is positioned at b2 and b8 of its Header subfield, indicating the number of RU Allocation subfields in CC1 422 is two and RU assignments specified by the two RU Allocation subfields 432, 434 start at the 3^{rd} 20 MHz subchannel of the 1^{st} 80 MHz frequency segment and the 1^{st} 20 MHz subchannel of the 3^{rd} 80 MHz frequency segment respectively. In accordance with the tables 4-6, the first RU Allocation subfield 432 of CC1 422 has a value of 170 indicating assignments of a RU combination of a 484-tone RU and a 996-tone RU in a 160 MHz frequency segments contributing three user fields to the User Specific field in CC1 422; and the second RU Allocation subfield 434 of CC1 422 has a value of 128 indicating an assignment of a RU combination of a 242-tone RU and a 484-tone RU in an 80 MHz frequency segments contributing one user field to the User Specific field of CC1 422.

On the other hand, in CC2 424, bit “1” is positioned at b2 and b9 of the Header subfield, indicating the number of RU Allocation subfields is two and RU assignments specified by the two RU Allocation subfields 436, 438 start at the 3^{rd} 20 MHz subchannel of the 1^{st} 80 MHz frequency segment and the 2^{nd} 20 MHz subchannel of the 3^{rd} 80 MHz frequency segment respectively. In accordance with the tables 4-6, the first RU Allocation subfield 432 of CC1 424 has a value of 168 indicating assignments of a RU combination of a 484-tone RU and a 996-tone RU in a 160 MHz frequency segment contributing one user field to the User Specific field of CC2 424, and the second RU Allocation subfield 438 of CC2 424 has a value of 46 indicating three small-size RUs or RU combinations of a 132-tone RU and two 52-tone RUs contributing three user fields to the User Specific field of CC2 424. It is noted that each of CC1 422 and CC2 424 has four user fields in its User Specific field for load balancing purpose.

Regarding Common field Option 2, the Common field 302 comprises one or more RU Allocation subfield 310 followed by a CRC field and tails bit, and does not comprise a Header subfield. The number of RU Allocation subfields, N, are dependent on the BW. For example, there are one RU Allocation subfield for a 20 MHz or 40 MHz BW PPDU, 2 for an 80 MHz BW PPDU, 4 for 160 MHz BW PPDU, 6 for 240 MHz BW PPDU and 8 for 320 MHz BW PPDU. The RU Allocation subfield 310 indicates RU assignment(s), including the size of the RU(s) or RU combinations and their placement in the frequency domain, to be used in the EHT modulated fields of the PPDU; and also indicates information needed to compute the number of users allocated to each RU or RU combination. According to the present disclosure, the subcarrier indices of the RU(s) or RU combination(s) shall be within a corresponding 20 MHz subchannel or overlap with a corresponding 20 MHz subchannel if the RU or RU combination is larger than 242-tone RU.

In an embodiment, in an 80 MHz frequency segment where compression mode is enabled, there is no RU Allocation subfield(s). Such compression mode in an 80 MHz frequency segment can be enabled if all STA(s) parking in the 80 MHz frequency segment engage in a non-OFDMA transmission.

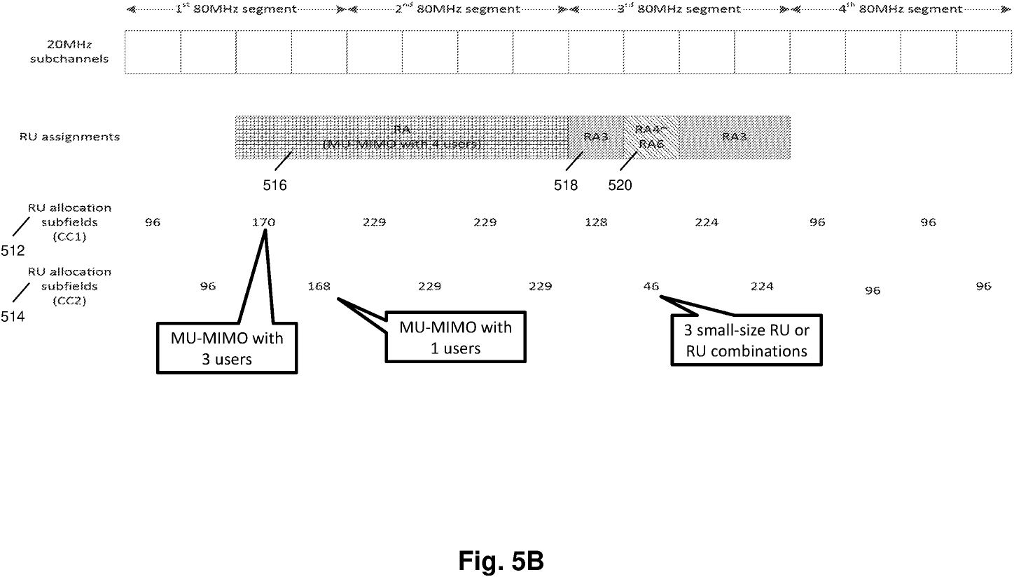

FIG. 5A depicts example common fields of EHT-SIG CC1 502 and CC2 504 transmitted in an 80 MHz frequency segment used for signalling large-size RU assignments and large-size RU combination assignments in a 320 MHz BW PPDU. In this example, three RUs or RU combinations are assigned, in particular: (i) a large-size RU allocation (RA1) 506 in 1^{st} and 2^{nd} 80 MHz frequency segments for a MU-MIMO transmission with four users, (ii) a large-size RU allocation (RA2) 508 in 3^{rd} 80 MHz frequency segment for a non-MU-MIMO transmission, and (iii) a large-size RU allocation (RA3) 510 in 2^{nd} 20 MHz subchannel of 3^{rd} 80 MHz frequency segment for a non-MU-MIMO transmission.

The CC1 502 comprises eight RU Allocation subfields with values of 96, 169, 229, 229, 128, 224, 96 and 96 which correspond to the 1^{st}, 3^{rd}, 5^{th}, 7^{th}, 9^{th}, 11^{th}, 13^{th} and 15^{th} 20 MHz frequency segments respectively; whereas the CC2 504 comprises eight RU Allocation subfields with values of 96, 169, 229, 229, 64, 224, 96 and 96 which correspond to the 2^{nd}, 4^{th}, 6^{th}, ^{8th}, 10^{th}, 12^{1h,} 14^{th} and 16^{th} 20 MHz frequency segments. In accordance with the tables 4-6, a RU Allocation subfield value of 96 indicates a 242-tone RU but with zero users (corresponding to no user field in User Specific field); a value of 169 indicates a RU combination of a 484-tone RU and a 996-tone RU in a 160 MHz frequency segment contributing two user fields to the User Specific field; a value of 229 indicates a RU combination of a 484-tone RU and a 996-tone RU in the 160 MHz frequency segment contributing zero user field to the User Specific field; a value of 128 indicates a RU combination of a 242-tone RU and a 484-tone RU in an 80 MHz frequency segment contributing one user field to the User Specific field; a value of 224 indicates that a RU combination of a 242-tone RU and a 484-tone RU in an 80 MHz frequency segment contributing zero user field to the User Specific field; and a value of 64 indicates a single RU assignment of 242-tone RU contributing one user to the User Specific field. Each of CC1 502 and CC2 504 has three user fields in its User Specific field for load balancing purpose.

FIG. 5B depicts example common fields of EHT-SIG CC1 512 and CC2 514 transmitted in an 80 MHz frequency segment used for signalling a mix of small-size RU or RU combination assignments and large-size RU or RU combination assignments in a 320 MHz BW PPDU. In this example, five RUs or RU combinations are assigned, in particular: (i) a large-size RU allocation (RA1) 516 for a MU-MIMO transmission with 4 users in 1^{st} and 2^{nd} 80 MHz frequency segments, (ii) a large-size RU allocation (RA2) 518 in 3^{rd} 80 MHz frequency segment and (iii) three small-size RU or RU combination allocations (RA3-RA5) 520 in 2^{nd} 20 MHz subchannel of 3^{rd} 80 MHz frequency segment.

The CC1 512 comprises eight RU Allocation subfields with values of 96, 170, 229, 229, 128, 224, 96 and 96 which correspond to the 1^{st}, 3^{rd}, 5^{th}, 7^{th}, 9^{th}, 11^{th}, 13^{th} and 15^{th} 20 MHz frequency segments respectively; whereas the CC2 514 comprises eight RU Allocation subfields with values of 96, 168, 229, 229, 46, 224, 96 and 96 which correspond to the 2^{nd} 4^{th}, 6^{th}, 8^{th}, 10^{th}, 12^{th}, 14^{th} and 16^{th} 20 MHz frequency segments. In accordance with the tables 4-6, a RU Allocation subfield value of 96 indicates a 242-tone RU but with zero users (corresponding to no user field in User Specific field); a value of 168 indicates a RU combination of a 484-tone RU and a 996-tone RU in a 160 MHz frequency segment contributing one user field to the User Specific field; a value of 229 indicates a RU combination of a 484-tone RU and a 996-tone RU in the 160 MHz frequency segment contributing zero user field to the User Specific field; a value of 128 indicates a RU combination of a 242-tone RU and a 484-tone RU in an 80 MHz frequency segment contributing one user field to the User Specific field; a value of 224 indicates that a RU combination of a 242-tone RU and a 484-tone RU in an 80 MHz frequency segment contributing zero user field to the User Specific field; and a value of 46 indicates three small-size RUs or RU combinations of a 132-tone RU and two 52-tone RUs contributing three user fields to the User Specific field. Each of CC1 512 and CC2 514 has four user fields in its User Specific field for load balancing purpose.

As mentioned above, RU assignment information for a STA shall be completely indicated in EHT-SIG field transmitted in the STA’s listening 80 MHz frequency segment (L80) such that the STA only needs to process pre-EHT modulated fields in the STA’s L80.

According to the present disclosure, a STA may have a RU assignment outside the STA’s L80 used for EHT modulated fields of an EHT basic PPDU if the STA is an 80+80 MHz or 160 MHz operating STA, 160+80 MHz or 240 MHz STA or a 160+160 MHz or 320 MHz operating STA. Advantageously, this may beneficial for frequency-selective scheduling and load-balancing among 80 MHz frequency segments if a large-size RU or RU combination can be assigned to a STA outside the STA’s L80. In this way, a STA’s capability of receiving a RU assignment outside its L80 shall be indicated to the AP, for example through an Operating Mode Indication (OMI) procedure. In various embodiments, if an 80+80 MHz operating STA using dual radios which process two 80 MHz segments respectively, the STA may suspend one radio which doesn’t handle L80 for power saving. In that case, the STA may not be able to receive a RU assignment outside its L80. If a 160+80 MHz operating STA using dual radios which process 160 MHz and 80 MHz frequency segments respectively, the STA may suspend one radio which doesn’t handle L80 for power saving. In that case, the STA may not be able to receive a RU assignment outside its L80 if the 80 MHz frequency segment is L80; but the STA may be able to receive a RU allocation outside its L80 if the RU assignment is located in the 160 MHz frequency segment which includes the L80. If a 160+160 MHz operating STA using dual radios which process two 160 MHz frequency segments respectively, the STA may suspend one radio which doesn’t handle L80 for power saving. In that case, the STA may not be able to receive a RU assignment outside its L80 if the RU assignment is located in a 160 MHz frequency segment which does not include the L80; but the STA may be able to receive a RU assignment outside its L80 if the RU assignment is located in a 160 MHz frequency segment which includes the L80.

However, it should be disallowed to assign a small-size RU or RU combination to a STA outside the STA’s L80 due to lack of benefits in terms of frequency diversity scheduling.

To achieve the above technical advantages, it is an object of present disclosure to substantially overcome the existing challenges to provide communication apparatuses and methods for a MU-MIMO transmission that allows an EHT basic PPDU to be transmitted to multiple STAs which may park in different 80 MHz frequency segments.

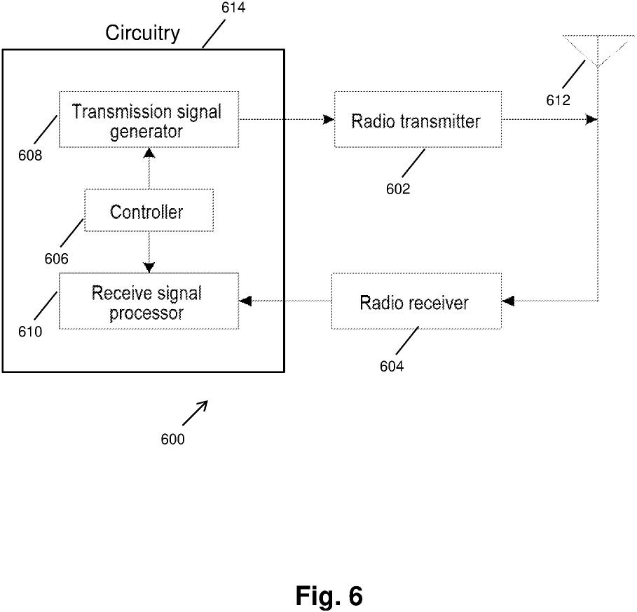

FIG. 6 shows a schematic, partially sectioned view of a communication apparatus 600 according to the present disclosure. The communication apparatus 600 may be implemented as an AP or an STA.

As shown in FIG. 6, the communication apparatus 600 may include circuitry 614, at least one radio transmitter 602, at least one radio receiver 604, and at least one antenna 612 (for the sake of simplicity, only one antenna is depicted in FIG. 6 for illustration purposes). The circuitry 614 may include at least one controller 606 for use in software and hardware aided execution of tasks that the at least one controller 606 is designed to perform, including control of OFDMA or non-OFDMA communications with one or more other communication apparatuses in a MIMO wireless network. The circuitry 614 may furthermore include at least one transmission signal generator 608 and at least one receive signal processor 610. The at least one controller 606 may control the at least one transmission signal generator 608 for generating PPDUs (for example PPDUs used for non-trigger-based communications) to be sent through the at least one radio transmitter 602 to one or more other communication apparatuses and the at least one receive signal processor 610 for processing PPDUs (for example PPDUs used for non-trigger-based communications received through the at least one radio receiver 604 from the one or more other communication apparatuses under the control of the at least one controller 606. The at least one transmission signal generator 608 and the at least one receive signal processor 610 may be stand-alone modules of the communication apparatus 600 that communicate with the at least one controller 606 for the above-mentioned functions, as shown in FIG. 6. Alternatively, the at least one transmission signal generator 608 and the at least one receive signal processor 610 may be included in the at least one controller 606. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 602, at least one radio receiver 604, and at least one antenna 612 may be controlled by the at least one controller 606.

The communication apparatus 600, when in operation, provides functions required for a MU-MIMO transmission. For example, the communication apparatus 600 may be an AP, and the circuitry 614 (for example the at least one transmission signal generator 608 of the circuitry 614) may, in operation, generates a PPDU comprising a signal field that indicates RU assignment information for a plurality of other communication apparatuses. The radio transmitter 602 may in operation, transmits the PPDU to the plurality of other communication apparatuses in two or more 80 MHz frequency segments; wherein when one of the plurality of other communication apparatuses parks in one of the two or more 80 MHz frequency segments, RU assignment information corresponding to the one of the plurality of other communication apparatuses is indicated in the signal field transmitted in the one of the two or more 80 MHz frequency segments.

The communication apparatus 600 may be a STA, and the radio receiver 604 may, in operation, receives a PPDU comprising a signal field that indicates RU assignment information for the communication apparatus transmitted in two or more 80 MHz frequency segments. The circuitry 314 (for example the at least one receive signal processor 610 of the circuitry 314) may, in operation, processes the PPDU, wherein when the communication apparatus parks in one of the two or more 80 MHz frequency segments, RU assignment information corresponding to the communication apparatuses is indicated in the signal field transmitted in the one of the two or more 80 MHz frequency segments.

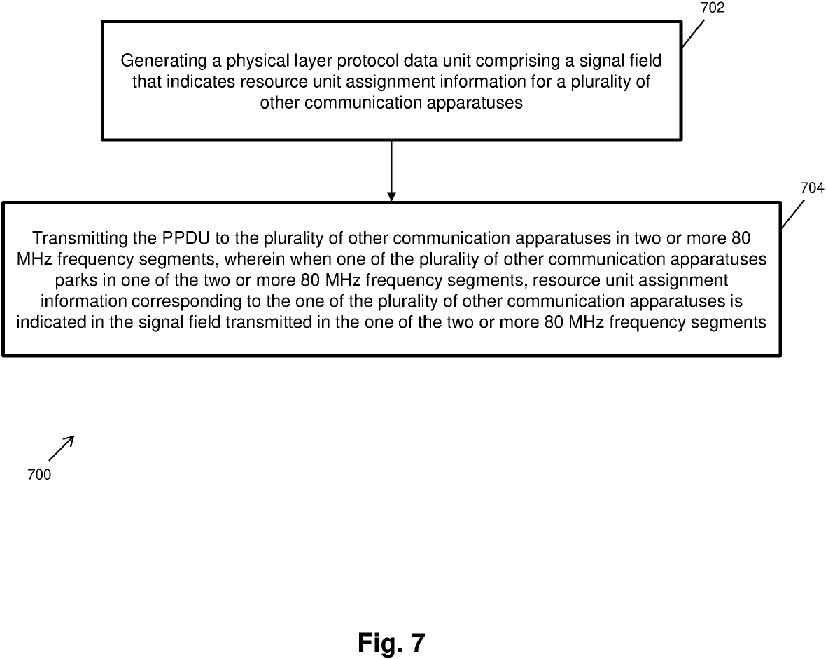

FIG. 7 shows a flow diagram 700 illustrating a communication method for transmitting generated PPDU according to the present disclosure. In step 702, a PPDU is generated, the PPDU comprising a signal field that indicates RU assignment information for a plurality of other communication apparatuses. In step 704, the generated PPDU is transmitted to the plurality of other communication apparatuses in two or more 80 MHz frequency segments, wherein when one of the plurality of other communication apparatuses parks in one of the two or more 80 MHz frequency segments, RU assignment information corresponding to the one of the plurality of other communication apparatuses is indicated in the signal field transmitted in the one of the two or more 80 MHz frequency segments.

According to the present disclosure, there are two options of MU-MIMO transmissions, in particular, under Option 1, only STAs parking in a same 80 MHz frequency segment are allowed to be multiplexed in a MU-MIMO transmission; whereas under Option 2, STAs parking in different 80 MHz frequency segments are allowed to be multiplexed in a MU-MIMO transmission if they are capable of receiving the MU-MIMO transmission. Advantageously, Option 2 of MU-MIMO transmission offers improved scheduling flexibility. It is noted that STAs that support a maximum BW of 80 MHz and park in different 80 MHz frequency segments are disallowed to be multiplexed in a MU-MIMO transmission since a STA cannot change its centre frequency during reception of an EHT basic PPDU.

Regarding Option 1 of MU-MIMO transmission, where only STAs parking in a same 80 MHz frequency segment are allowed to be multiplexed in a MU-MIMO transmission, user fields corresponding to all the STAs multiplexed in a MU-MIMO transmission are included in the User Specific field 304 of the EHT-SIG field 204. Under Option 1 of MU-MIMO transmission, the RU Allocation subfield format as shown in Tables 4-6 can be used. Table 1 depicts an example user field for Option 1 of MU-MIMO transmission. It is noted that similar to 11ax, a STA determines whether a user field is for MU-MIMO allocation or non-MU-MIMO allocation based on number of users multiplexed in corresponding allocation as indicated in the RU Allocation subfield. Further, similar to 11ax, a STA multiplexed in a MU-MIMO allocation derives starting stream index and number of spatial streams according to the Spatial Configuration field value and user field position in the User Specific field, as shown in Tables 8-13.

TABLE 1

An example format of user field of EHT-SIG field 204 for MU-MIMO allocation

| Field name | Field size (bits) |
|---|---|
| STA ID | 11 |
| EHT MCS | 4 |
| Spatial Configuration | 6 |
| Coding | 1 |
| Total | 22 |

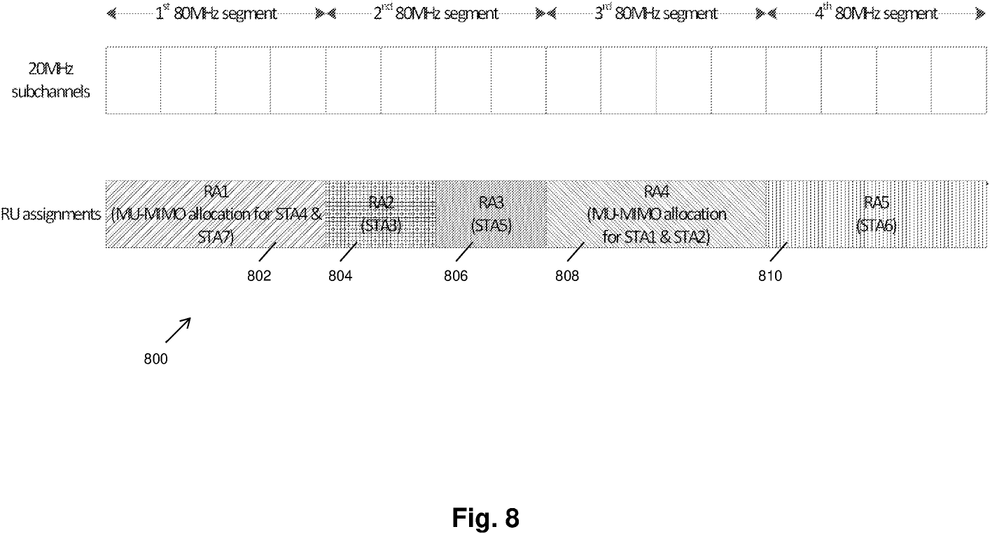

FIG. 8 depicts example RU assignments in a 320 MHz channel. In this example, five RUs are assigned, in particular: (i) a RU allocation 1 (RA1) for a MU-MIMO transmission with 2 users STA4 and STA7 in 1^{st} 80 MHz frequency segment, (ii) RA2 for STA3 in 1^{st} and 2^{nd} 20 MHz subchannels of 2^{nd} 80 MHz frequency segment, (iii) RA3 for STA5 in 3^{rd} and 4^{th} 20 MHz subchannel of the 2^{nd} 80 MHz frequency segment, (iv) RA4 for a MU-MIMO transmission with 2 users STA1 and STA2 in 3^{rd} 80 MHz frequency segment, and (v) RA5 for STA6 in 4^{th} 80 MHz frequency segment. According to an embodiment, STA3, STA4, STA5 and STA7 support BW of larger than 80 MHz (e.g. 160 MHz or 80+80 MHz). STA3 and STA5 park in the 1^{st} 80 MHz frequency segment, STA4 and STA7 park in the 2^{nd} 80 MHz frequency segment, STA1 and STA2 park in the 3^{rd} 80 MHz frequency segment and STA6 parks in the 4^{th} frequency segment. In this embodiment, it is noted that STA3, STA4, STA5 and STA7 have their RU assignments outside their L80s used for EHT modulated fields.

For the example RU assignments as shown in FIG. 8, under Option 1 of MU-MIMO transmission and assuming Option 1 of Common field (with Header subfield), in the EHT-SIG CC1 and EHT-SIG CC2 for each 80 MHz frequency segment, Header subfield, RU Allocation subfields and User Specific field can be set as follows:
EHT-SIG CC1:
   Header subfield:
      1^{st} 80 MHz frequency segment: 0000100000000000
      2^{nd} 80 MHz frequency segment: 1000000000000000
      3^{rd} 80 MHz frequency segment: 0000000010000000
      4^{th} 80 MHz frequency segment: 0000000000001000
   RU Allocation subfields
      1^{st} 80 MHz frequency segment: 72 (RU484 with a single user)
      2^{nd} 80 MHz frequency segment: 80 (RU996 with a single user)
      3^{rd} 80 MHz frequency segment: 80 (RU996 with a single user)
      4^{th} 80 MHz frequency segment: 80 (RU996 with a single user)
   User Specific field
      1^{st} 80 MHz frequency segment: user field for STA3
      2^{nd} 80 MHz frequency segment: user field for STA4
      3^{rd} 80 MHz frequency segment: user field for STA1
      4^{th} 80 MHz frequency segment: user field for STA6
EHT-SIG CC2:
   Header subfield:
      1^{st} 80 MHz frequency segment: 0000001000000000
      2^{nd} 80 MHz frequency segment: 1000000000000000
      3^{rd} 80 MHz frequency segment: 0000000010000000
      4^{th} 80 MHz frequency segment: 0000000000001000
   RU Allocation subfields
      1^{st} 80 MHz frequency segment: 72 (RU484 with a single user)
      2^{nd} 80 MHz frequency segment: 80 (RU996 with a single user)
      3^{rd} 80 MHz frequency segment: 80 (RU996 with a single user)
      4^{th} 80 MHz frequency segment: 98 (RU996 which contributes zerouser fields in CC2)
   User Specific field
      1^{st} 80 MHz frequency segment: user field for STA5
      2^{nd} 80 MHz frequency segment: user field for STA7
      3^{rd} 80 MHz frequency segment: user field for STA2
      4^{th} 80 MHz frequency segment: zero user field

In this example, STA3 and STA5 which park in the same 80 MHz frequency segment are not multiplexed in a MU-MIMO transmission. The Header subfields of CC1 and CC2 transmitted in the 1^{st} 80 MHz frequency segment have bit “1” positions in b5 and b7 respectively indicating the users or STAs parking in the 1^{st} 80 MHz frequency segment, i.e. STA3 and STA5, have their RU assignment information indicated in RU Allocation subfields transmitted in the 1^{st} 80 MHz frequency segment. The value of 72 in the RU Allocation subfields indicates RA2 and RA3 contributing one user field to the User Specific field in CC1 and CC2 respectively. As such, as a single user field for STA3 in CC1 and CC2 is associated with RA2 and a single user field for STA5 in CC1 and CC2 is associated with RA3, this results in a non-MU-MIMO transmission to STA3 in RA2 and a non-MU-MIMO transmission to STA5 in RA3.

According to Option 1 of MU-MIMO transmission, STAs parking in a same 80 MHz frequency segment, e.g. STA4 and STA7 parking in the 2^{nd} 80 MHz frequency segment, are allowed to be multiplexed in a MU-MIMO transmission. The Header subfields of CC1 and CC2 transmitted in the 2^{nd} 80 MHz frequency segment both have bit “1” positions in b1 indicating the users or STAs parking in the 2^{nd} 80 MHz frequency segment, i.e. STA4 and STA7, have their RU assignment information indicated in RU Allocation subfields transmitted in the 2^{nd} 80 MHz frequency segment. The value of 80 in the RU Allocation subfields indicates RA1 contributing one user field to the User Specific field in each of CC1 and CC2. As such, as two user fields for STA4 and STA7 in CC1 and CC2 are associated with RA1, this results in a MU-MIMO transmission to STA4 and STA7 in RA1.

Similarly, STA1 and STA2 which park in the 3^{rd} 80 MHz frequency segment are allowed to be multiplexed in a MU-MIMO transmission. The Header subfields of CC1 and CC2 transmitted in the 3^{rd} 80 MHz frequency segment both have bit “1” positions in b9 indicating the users or STAs parking in the 3^{rd} 80 MHz frequency segment, i.e. STA1 and STA2, have their RU assignment information indicated in RU Allocation subfields transmitted in the 3^{rd} 80 MHz frequency segment. The value of 80 in the RU Allocation subfields indicates RA4 contributing one user field to the User Specific field in each of CC1 and CC2. As such, as two user fields for STA1 and STA2 in CC1 and CC2 are associated with RA4, this results in a MU-MIMO transmission to STA1 and STA2 in RA4.

The Header subfields of CC1 and CC2 transmitted in the 4^{th} 80 MHz frequency segment both have bit “1” positions in b13 indicating the user(s) or STA(s) parking in the 4^{th} 80 MHz frequency segment, i.e. STA6, has its RU assignment information indicated in RU Allocation subfield transmitted in the 4^{th} 80 MHz frequency segment. The value of 80 in the RU Allocation subfield of CC1 indicates RA5 contributing one user field to the User Specific field in CC1 and the value of 98 in the RU Allocation subfield of CC2 indicate a dummy RU assignment contributing zero user field to the User Specific field in CC2. As such, as a single user field for STA6 in CC1 and CC2 is associated with RA5, this results in a non-MU-MIMO transmission to STA6 in RA5.

For the example RU assignments as shown in FIG. 8, under Option 1 of MU-MIMO transmission and assuming Option 2 of Common field (without Header subfield), in the EHT-SIG CC1 and EHT-SIG CC2 for each 80 MHz frequency segment, RU Allocation subfields and User Specific field can be set as follows:
EHT-SIG CC1:
   RU Allocation subfields
      1^{st} 80 MHz frequency segment: 98 (RU996 which contributes zero user fields in CC1), 98 (RU996 which contributes zero user fields in CC1), 72 (RU484 with a single user), 97 (RU484 which contributes zero user fields in CC1), 98 (RU996 which contributes zero user fields in CC1), 98 (RU996 which contributes zero user fields in CC1), 98 (RU996 which contributes zero user fields in CC1), 98 (RU996 which contributes zero user fields in CC1)
      2^{nd} 80 MHz frequency segment: 80 (RU996 with a single user), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 98 (RU996 which contributes zero user fields in CC1), 98 (RU996 which contributes zero user fields in CC1)
      3^{rd} 80 MHz frequency segment: 98 (RU996 which contributes zero User fields in CC1), 98 (RU996 which contributes zero user fields in CC1), 97 (RU484 which contributes zero user fields in CC1), 97 (RU484 which contributes zero user fields in CC1), 80 (RU996 with a single user), 98 (RU996 which contributes zero user fields in CC1), 98 (RU996 which contributes zero user fields in CC1), 98 (RU996 which contributes zero user fields in CC1)
      4^{th} 80 MHz frequency segment: 98 (RU996 which contributes zero User fields in CC1), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 80 (RU996 with a single user), 98 (RU996 which contributes zero user fields in CC1)
   User Specific field
      1^{st} 80 MHz frequency segment: user field for STA3
      2^{nd} 80 MHz frequency segment: user field for STA4
      3^{rd} 80 MHz frequency segment: user field for STA1
      4^{th} 80 MHz frequency segment: user field for STA6
EHT-SIG CC2:
   RU Allocation subfield
      1^{st} 80 MHz frequency segment: 98 (RU996 which contributes zero user fields in CC2), 98 (RU996 which contributes zero user fields in CC2), 97 (RU484 which contributes zero user fields in CC2), 72 (RU484 with a single user), 98 (RU996 which contributes zero user fields in CC2, RU996 which contributes zero user fields in CC2), 98 (RU996 which contributes zero user fields in CC2), 98 (RU996 which contributes zero user fields in CC2)
      2^{nd} 80 MHz frequency segment: 80 (RU996 with a single user), 98 (RU996 which contributes zero user fields in CC2), 97 (RU484 which contributes zero user fields in CC2), 97 (RU484 which contributes zero user fields in CC2), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
      3^{rd} 80 MHz frequency segment: 98 (RU996 which contributes zero user fields in CC2), 98 (RU996 which contributes zero user fields in CC2), 97 (RU484 which contributes zero user fields in CC2), 97 (RU484 which contributes zero user fields in CC2), 80 (RU996 with a single user), 98 (RU996 which contributes zero user fields in CC2), 98 (RU996 which contributes zero user fields in CC2), 98 (RU996 which contributes zero user fields in CC2)
      4^{th} 80 MHz frequency segment: 98 (RU996 which contributes zero user fields in CC2), 98 (RU996 which contributes zero user fields in CC2), 97 (RU484 which contributes zero user fields in CC2), 97 (RU484 which contributes zero user fields in CC2), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
   User Specific field
      1^{st} 80 MHz frequency segment: user field for STA5
      2^{nd} 80 MHz frequency segment: user field for STA7
      3^{rd} 80 MHz frequency segment: user field for STA2
      4^{th} 80 MHz frequency segment: zero user field

The RU Allocation subfields of CC1 and CC2 transmitted in the 1^{st} 80 MHz frequency segment have RU Allocation subfield values of 72 at placements corresponding to RA2 and RA3 (3^{rd} and 4^{th} RU Allocation subfield value in CC1 and CC2 respectively). The value of 72 in the RU Allocation subfield in CC1 indicates RA2 contributing one user field to the User Specific field in CC1, and the value of 72 in the RU Allocation subfield in CC2 indicates RA3 contributing one user field to the User Specific field in CC2. The remaining RU Allocation subfields in CC1 and CC2 have values of 97 and 98 indicating dummy RU assignments. As such, as a single user field for STA3 in CC1 and CC2 is associated with RA2 and a single user field for STA5 in CC1 and CC2 is associated with RA3, this results in a non-MU-MIMO transmission to STA3 in RA2 and a non-MU-MIMO transmission to STA5 in RA3.

According to the present disclosure, STA4 and STA7 which park in the 2^{nd} 80 MHz frequency segment are allowed to be multiplexed in a MU-MIMO transmission. The RU Allocation subfields of CC1 and CC2 transmitted in the 2^{nd} 80 MHz frequency segment have a value of 80 at a placement corresponding to RA1 (1^{st} RU Allocation subfield value in both CC1 and CC2). The value of 80 in the RU Allocation subfields indicates RA1 contributing one user field to the User Specific field in each of CC1 and CC2. The remaining RU Allocation subfields in CC1 and CC2 have values of 97 and 98 indicating dummy RU assignments. As such, as two user fields for STA4 and STA7 in CC1 and CC2 are associated with RA1, this results in a MU-MIMO transmission to STA4 and STA7 in RA1.

The RU Allocation subfields of CC1 and CC2 transmitted in the 3^{rd} 80 MHz frequency segment have a value of 80 at a placement corresponding to RA4 (5^{th} RU Allocation subfield value in both CC1 and CC2). The value of 80 in the RU Allocation subfields indicates RA4 contributing one user field to the User Specific field in each of CC1 and CC2. The remaining RU Allocation subfields in CC1 and CC2 have values of 97 and 98 indicating dummy RU assignments. As such, as two user fields for STA1 and STA2 in CC1 and CC2 are associated with RA4, this results in a MU-MIMO transmission to STA1 and STA2 in RA4.

The RU Allocation subfields of CC1 transmitted in the 4^{th} 80 MHz frequency segment have a value of 80 at a placement corresponding to RA5 (7^{th} RU Allocation subfield value in CC1). The value of 80 in the RU Allocation subfield in CC1 indicates RA5 contributing one user field to the User Specific field in CC1. The remaining RU Allocation subfields in CC1 and CC2 have values of 97 and 98 indicating dummy RU assignments. As such, as a single user field for STA6 in CC1 and CC2 is associated with RA5, this results in a non-MU-MIMO transmission to STA6 in RA5.

According to the present disclosure, under Option 2 of MU-MIMO transmission, STAs parking in different 80 MHz frequency segments are allowed to be multiplexed in a MU-MIMO transmission if they are capable of receiving the MU-MIMO transmission, for example if STAs support BW larger than 80 MHz e.g. 160 MHz, 80+80 MHz, 240 MHz, 160+80 MHz, 320 MHz or 160+160 MHz. In various embodiments, in an 80 MHz frequency segment in which at least one STA multiplexed in a MU-MIMO transmission parks, user fields corresponding to all the STAs multiplexed in the MU-MIMO transmission are included in the EHT-SIG field transmitted in the 80 MHz frequency segment. The user fields corresponding to STAs which park in different 80 MHz frequency segments are dummy user fields (with a special STA-ID of 2046). The RU Allocation field defined in Tables 4 to 6 and the user field for MU-MIMO allocation defined in Table 1 can be used. The ordering of STAs multiplexed in the MU-MIMO transmission may be kept the same in each of 80 MHz frequency segments in which at least one STA is multiplexed in the MU-MIMO transmission so that the same Spatial Configuration field can be set in all the user fields for STAs multiplexed in the MU-MIMO transmission. Advantageously, when a single STA parking in an 80 MHz frequency segment is multiplexed in a MU-MIMO transmission, the STA is still able to identify user fields for the MU-MIMO transmission correctly and thus receive the MU-MIMO transmission properly.

Returning to the example RU assignments in FIG. 8 where five RUs are assigned, in particular: (i) RA1 for a MU-MIMO transmission with 2 users STA4 and STA7 in 1^{st} 80 MHz frequency segment, (ii) RA2 for STA3 in 1^{st} and 2^{nd} 20 MHz subchannels of 2^{nd} 80 MHz frequency segment, (iii) RA3 for STA3 in 3^{rd} and 4^{th} 20 MHz subchannel of the 2^{nd} 80 MHz frequency segment, (iv) RA4 for a MU-MIMO transmission with 2 users STA1 and STA2 in 3^{rd} 80 MHz frequency segment, and (v) RA5 for STA6 in 4^{th} 80 MHz frequency segment. According to an embodiment, STA5 and STA7 support BW larger than 80 MHz. STA4 and STA5 park in the 1^{st} 80 MHz frequency segment. STA3 and STA7 park in the 2^{nd} 80 MHz frequency segment, STA1 and STA2 park in the 3^{rd} 80 MHz frequency segment and STA6 parks in the 4^{th} frequency segment. In this embodiment, it is noted that STA5 and STA7 have their RU assignments outside their L80s used for EHT modulated fields.

For the example RU assignments as shown in FIG. 8, under Option 2 of MU-MIMO transmission and assuming Option 1 of Common field (with Header subfield), in the EHT-SIG CC1 and EHT-SIG CC2 for each 80 MHz frequency segment, Header subfield, RU Allocation subfields and User Specific field can be set as follows:
EHT-SIG CC1
   Header subfield:
      1^{st} 80 MHz frequency segment: 1000000000000000
      2^{nd} 80 MHz frequency segment: 1000000000000000
      3^{rd} 80 MHz frequency segment: 0000000010000000
      4^{th} 80 MHz frequency segment: 0000000000001000
   RU Allocation subfields
      1^{st} 80 MHz frequency segment: 81 (RU996 with two users)
      2^{nd} 80 MHz frequency segment: 81 (RU996 with two users)
      3^{rd} 80 MHz frequency segment: 80 (RU996 with a single user)
      4^{th} 80 MHz frequency segment: 80 (RU996 with a single user)
   User Specific field
      1^{st} 80 MHz frequency segment: user field for STA4, dummy user field
      2^{nd} 80 MHz frequency segment: dummy user field, user field forSTA7
      3^{rd} 80 MHz frequency segment: user field for STA1 4^{th} 80 MHz frequency segment: user field for STA6
EHT-SIG CC2
   Header subfield:
      1^{st} 80 MHz frequency segment: 0000001000000000
      2^{nd} 80 MHz frequency segment: 0000100000000000
      3^{rd} 80 MHz frequency segment: 0000000010000000
      4^{th} 80 MHz frequency segment: 0000000000001000
   RU Allocation subfields
      1^{st} 80 MHz frequency segment: 72 (RU484 with a single user)
      2^{nd} 80 MHz frequency segment: 72 (RU484 with a single user)
      3^{rd} 80 MHz frequency segment: 80 (RU996 with a single user)
      4^{th} 80 MHz frequency segment: 98 (RU996 which contributes zerouser fields in CC2)
   User Specific field
      1^{st} 80 MHz frequency segment: user field for STA5
      2^{nd} 80 MHz frequency segment: user field for STA3
      3^{rd} 80 MHz frequency segment: user field for STA2
      4^{th} 80 MHz frequency segment: no user field

It is noted that STA4 and STA5 which park in the 1^{st} 80 MHz frequency segment have their RU assignments in the 1^{st} 80 MHz frequency segment and 2^{nd} 80 MHz frequency segment respectively; and STA3 and STA7 which park in the 2^{nd} 80 MHz frequency segment have their RU assignments in the 2^{nd} 80 MHz frequency segment and 1^{st} 80 MHz frequency segment respectively.

According to the present disclosure, STAs parking in different 80 MHz frequency segments e.g. STA4 and STA7 parking in the 1^{st} and 2^{nd} 80 MHz frequency segments respectively, are allowed to be multiplexed in a MU-MIMO transmission if they are capable of receiving the MU-MIMO transmission. In CC1, the Header subfield of CC1 transmitted in the 1^{st} or 2^{nd} 80 MHz frequency segment has bit “1” position in b1 indicating the users or STAs parking the 1^{st} or 2^{nd} frequency segment may have their RU assignment information indicated in RU Allocation subfield in the 1^{st} or 2^{nd} 80 MHz frequency segment. The value of 81 in the RU Allocation subfield in CC1 transmitted in the 1^{st} or 2^{nd} frequency segment indicates RA1 contributing two user fields to the User Specific field in CC1 transmitted in the 1^{st} or 2^{nd} frequency segment, i.e. for STA4 and STA7. As STA4 but not STA7 parks in the 1^{st} 80 MHz frequency segment, the user field corresponding to STA7 in CC1 transmitted in the 1^{st} 80 MHz frequency segment is a dummy user field. Similarly, as STA7 but not STA4 parks in the 2^{nd} 80 MHz frequency field, the user field corresponding to STA4 in CC1 transmitted in the 2^{nd} 80 MHz frequency segment is a dummy user field. As such, as two user fields for STA4 and STA7 in CC1 and CC2 are associated with RA1, this results in a MU-MIMO transmission to STA4 and STA7 in RA1. The ordering of STA4 and STA7 are kept the same in the User Specific field transmitted in the 1^{st} and 2^{nd} 80 MHz frequency segments.

In CC2, the Header subfield of CC2 transmitted in the 1^{st} 80 MHz frequency segment has bit “1” position in b7 indicating the users or STAs parking in the 1^{st} 80 MHz frequency segment may have their RU assignment information indicated in RU Allocation subfield in the 1^{st} 80 MHz frequency segment. The value of 72 in the RU Allocation subfields in CC2 transmitted in the 1^{st} 80 MHz frequency segment indicates RA3 contributing one user field to the User Specific field in CC2 transmitted in the 1^{st} 80 MHz frequency segment, i.e. for STA5. As such, as a single user for STA5 in CC1 and CC2 are associated with RA3, this results in a non-MU-MIMO transmission to STA5 in RA3. On the other hand, the Header subfield of CC2 transmitted in the 2^{nd} 80 MHz frequency segment has bit “1” position in b5 indicating the users or STAs parking in the 2^{nd} 80 MHz frequency segment may have their RU assignment information indicated in RU Allocation subfield in the 2^{nd} 80 MHz frequency segment. The value of 72 in the RU Allocation subfields in CC2 transmitted in the 2^{nd} frequency segment indicates RA2 contributing one user field to the User Specific field in CC2 transmitted in the 2^{nd} frequency segment, i.e. for STA3. As such, as a single user for STA3 in CC1 and CC2 are associated with RA2, this results in a non-MU-MIMO transmission to STA3 in RA2.

Additionally, STA1 and STA2 which park in the 3^{rd} 80 MHz frequency segment are allowed to be multiplexed in a MU-MIMO transmission. The Header subfields of CC1 and CC2 transmitted in the 3^{rd} 80 MHz frequency segment both have bit “1” positions in b9 indicating the users or STAs parking in the 3^{rd} 80 MHz frequency segment may have their RU assignment information indicated in RU Allocation subfields transmitted in the 3^{rd} 80 MHz frequency segment. The value of 80 in the RU Allocation subfields indicates RA4 contributing one user field to the User Specific field in each of CC1 and CC2 transmitted in the 3^{rd} 80 MHz frequency segment, i.e. for STA1 and STA2 respectively. As such, as two user fields for STA1 and STA2 in CC1 and CC2 are associated with RA4, this results in a MU-MIMO transmission to STA1 and STA2 in RA4.

The Header subfields of CC1 and CC2 transmitted in the 4^{th} 80 MHz frequency segment both have bit “1” positions in b13 indicating the user(s) or STA(s) parking in the 4^{th} 80 MHz frequency segment may have its RU assignment information indicated in RU Allocation subfield transmitted in the 4^{th} 80 MHz frequency segment. The value of 80 in the RU Allocation subfield of CC1 and the value of 98 in the RU Allocation subfield of CC2 indicate RA5 contributing one user field and zero user field to the User Specific fields in CC1 and CC2 transmitted in the 4^{th} 80 MHz frequency segment respectively. As such, as a single user field for STA6 in CC1 and CC2 is associated with RA5, this results in a non-MU-MIMO transmission to STA6 in RA5.

Under Option 1 of MU-MIMO transmission and assuming Option 2 of Common field (without Header subfield), in the EHT-SIG CC1 and EHT-SIG CC2 for each 80 MHz frequency segment, RU Allocation subfields and User Specific field can be set as follows:
EHT-SIG CC1:
   RU Allocation subfields
      1^{st} 80 MHz frequency segment: 81 (RU996 with two users), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 98 (RU996 which contributes zero user fields in CC1), 98 (RU996 which contributes zero user fields in CC1)
      2^{nd} 80 MHz frequency segment: 81 (RU996 with two users), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 98 (RU996 which contributes zero user fields in CC1), 98 (RU996 which contributes zero user fields in CC1)
      3^{rd} 80 MHz frequency segment: 98 (RU996 which contributes zero user fields in CC1), 98 (RU996 which contributes zero user fields in CC1), 97 (RU484 which contributes zero user fields in CC1), 97 (RU484 which contributes zero user fields in CC1), 80 (RU996 with a single user), 98 (RU996 which contributes zero user fields in CC1), 98 (RU996 which contributes zero user fields in CC1), 98 (RU996 which contributes zero user fields in CC1)
      4^{th} 80 MHz frequency segment: 98 (RU996 which contributes zero user fields in CC1), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 80 (RU996 with a single user), 98 (RU996 which contributes zero user fields in CC1)
   User Specific field
      1^{st} 80 MHz frequency segment: user field for STA4, dummy user field
      2^{nd} 80 MHz frequency segment: dummy user field, user field forSTA7
      3^{rd} 80 MHz frequency segment: user field for STA1
      4^{th} 80 MHz frequency segment: user field for STA6
EHT-SIG CC2:
   RU Allocation subfields
      1^{st} 80 MHz frequency segment: 98 (RU996 which contributes zero user fields in CC2), 98 (RU996 which contributes zero user fields in CC2), 97 (RU484 which contributes zero user fields in CC2), 72 (RU484 with a single user), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
      2^{nd} 80 MHz frequency segment: 98 (RU996 which contributes zero user fields in CC2), 98 (RU996 which contributes zero user fields in CC2), 72 (RU484 with a single user), 97 (RU484 which contributes zero user fields in CC2), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
      3^{rd} 80 MHz frequency segment: 98 (RU996 which contributes zero user fields in CC2), 98 (RU996 which contributes zero user fields in CC2), 97 (RU484 which contributes zero user fields in CC2), 97 (RU484 which contributes zero user fields in CC2), 80 (RU996 with a single user), 98 (RU996 which contributes zero user fields in CC2), 98 (RU996 which contributes zero user fields in CC2), 98 (RU996 which contributes zero user fields in CC2)
      4^{th} 80 MHz frequency segment: 98 (RU996 which contributes zero user fields in CC2), 98 (RU996 which contributes zero user fields in CC2), 97 (RU484 which contributes zero user fields in CC2), 97 (RU484 which contributes zero user fields in CC2), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
   User Specific field
      1^{st} 80 MHz frequency segment: user field for STA5
      2^{nd} 80 MHz frequency segment: user field for STA3
      3^{rd} 80 MHz frequency segment: user field for STA2
      4^{th} 80 MHz frequency segment: no user field

In CC1, the RU Allocation subfield of CC1 transmitted in the 1^{st} or 2^{nd} 80 MHz frequency segment has a value of 81 at a placement corresponding to RA1 (1^{st} RU Allocation subfield value). This indicates that the users or STAs parking in the 1^{st} or 2^{nd} 80 MHz frequency segment, in this case STA4 and STA7, may have their RU assignment information indicated in the 1^{st} or 2^{nd} 80 MHz frequency segment. The value of 81 indicates RA1 contributing two user fields to the User Specific field in CC1 transmitted in the 1^{st} or 2^{nd} frequency segment, i.e. for STA4 and STA7. As STA4 but not STA7 parks in the 1^{st} 80 MHz frequency segment, the user field corresponding to STA7 in the 1^{st} 80 MHz frequency segment is a dummy user field. Similarly, as STA7 but not STA4 parks in the 2^{nd} 80 MHz frequency field, the user field corresponding to STA4 in the 2^{nd} 80 MHz frequency segment is a dummy user field. As such, as two user fields for STA4 and STA7 in CC1 and CC2 are associated with RA1, this results in a MU-MIMO transmission to STA4 and STA7 in RA1. The ordering of STA4 and STS7 are kept the same in the User Specific fields of the 1^{st} and 2^{nd} 80 MHz frequency segments.

In CC2, the RU Allocation subfield of CC2 transmitted in the 1^{st} or 2^{nd} 80 MHz frequency segment have a value of 72 at a placement corresponding to RA3 or RA2 (4^{th} or 3^{rd} RU Allocation subfield value). This indicates that the users or STAs parking in the 1^{st} or 2^{nd} 80 MHz frequency segment, in this case STA5 and STA3, may have their RU assignment information indicated in the 1^{st} or 2^{nd} 80 MHz frequency segment. The value of 72 indicates RA3 or RA2 contributing one user field to the User Specific field in CC2 transmitted in the 1^{st} or 2^{nd} frequency segment, i.e. for STA5 or STA3. The remaining RU Allocation subfields in CC1 and CC2 have values of 97 and 98 indicating dummy RU assignments. As such, as a single user field for STA5 or STA3 in CC1 and CC2 is associated with RA3 or RA2, this results in a non-MU-MIMO transmission to STA5 in RA3 and a non-MU-MIMO transmission to STA3 in RA2.

The RU Allocation subfields of CC1 and CC2 transmitted in the 3^{rd} 80 MHz frequency segment have a value of 80 at placements corresponding to RA4 (5^{th} RU Allocation subfield value in both CC1 and CC2). This indicates that the users or STAs parking in the 3^{rd} 80 MHz frequency segment, i.e. STA1 and STA2, may have their RU assignment information indicated in the 3^{rd} 80 MHz frequency segment. The value of 80 in the RU Allocation subfields indicates RA4 contributing one user field to the User Specific field in each of CC1 and CC2 transmitted in the 3^{rd} 80 MHz frequency segment, i.e. for STA1 and STA2 respectively. The remaining RU Allocation subfields in CC1 and CC2 have values of 97 and 98 indicating dummy RU assignments. As such, as two user fields for STA1 and STA2 in CC1 and CC2 are associated with RA4, this results in a MU-MIMO transmission to STA1 and STA2 in RA4.

The RU Allocation subfields of CC1 transmitted in the 4^{th} 80 MHz frequency segment have a value of 80 at placement corresponding to RA5 (7^{th} RU Allocation subfield value in both CC1 and CC2). This indicates that the users or STAs parking in the 4^{th} 80 MHz frequency segment, i.e. STA6, may have their RU assignment information indicated in the 4^{th} 80 MHz frequency segment. The value of 80 in the RU Allocation subfield in CC1 indicates RA5 contributing one user field to the User Specific field in the CC1 transmitted in the 4^{th} 80 MHz frequency segment, i.e. for STA6. The remaining RU Allocation subfields in CC1 and CC2 have values of 97 and 98 indicating dummy RU assignments. As such, as a single user for STA6 in CC1 and CC2 is associated with RA5, this results in a non-MU-MIMO transmission to STA6 in RA5.

According to the present disclosure, under Option 2 of MU-MIMO transmission, STAs parking in different 80 MHz frequency segments are allowed to be multiplexed in a MU-MIMO transmission if they are capable of receiving the MU-MIMO transmission, for example if the STAs support BW larger than 80 MHz. In various embodiments, in an 80 MHz frequency segment in which at least one STA multiplexed in a MU-MIMO transmission parks, user fields corresponding to the at least one STAs multiplexed in the MU-MIMO transmission are included in the EHT-SIG field transmitted in the 80 MHz frequency segment. In one embodiment, no dummy user field is used to indicate the user fields corresponding to STAs which park in the different 80 MHz frequency segments. Advantageously, the EHT-SIG field signalling overhead may be reduced.

There are two options to achieve so: Option 2A and Option 2B. In Option 2A, the RU Allocation subfield format and the user field format may be redesigned. As such, each RU Allocation subfield in an 80 MHz frequency segment indicates whether a large-size RU or RU combination assignment for a single user is a MU-MIMO allocation or a non-MU-MIMO allocation as shown in Table 7; while in user field, Starting Stream Index subfield (4 bits) and Number of Spatial Streams subfield (2 bits) are used to indicate the starting stream index and the number of spatial stream respectively instead of Spatial Configuration subfield (6 bits), as shown in Table 2. The Coding subfield indicates whether binary convolutional coding (BCC) or low density parity-check code (LDPC) is used. Advantageously, when a single STA parking in an 80 MHz frequency segment is multiplexed in a MU-MIMO transmission, the STA is still able to identify user field for MU-MIMO allocation correctly and thus receive the MU-MIMO transmission properly.

TABLE 2

Another example format of user field of EHT-SIG field 204 for MU-MIMO allocation

| Field name | Field size (bits) |
|---|---|
| STA ID | 11 |
| Starting Stream Index | 4 |
| Number of Spatial Stream | 2 |
| MCS | 4 |
| Coding | 1 |
| Total | 22 |

In Option 2B, RU Allocation subfield format defined in Tables 4 to 6 may be reused, but the user field format for MU-MIMO allocation may be redesigned. In an embodiment, a Format subfield is added in the user field to indicate whether the use field is for non-MU-MIMO allocation or MU-MIMO allocation, and a Starting Stream Index subfield (4 bits) and a Number of Spatial Streams subfield (2 bits) are used to indicate the starting stream index and the number of spatial stream respectively instead of Spatial Configuration subfield (6 bits), as shown in Table 3. Advantageously, when a single STA parking in an 80 MHz frequency segment is multiplexed in a MU-MIMO transmission, the STA is still able to identify user field for MU-MIMO allocation correctly and thus receive the MU-MIMO transmission properly.

TABLE 3

Yet another example format of user field of EHT-SIG field 204 for MU-MIMO allocation

| Field name | Field size (bits) |
|---|---|
| Format | 1 |
| STA ID | 11 |
| Starting Stream Index | 4 |
| Number of Spatial Stream | 2 |
| MCS | 4 |
| Coding | 1 |
| Total | 23 |

Returning to the example RU assignments in FIG. 8 where five RUs are assigned, in particular: (i) RA1 for a MU-MIMO transmission with 2 users STA4 and STA7 in 1^{st} 80 MHz frequency segment, (ii) RA2 for STA3 in 1^{st} and 2^{nd} 20 MHz subchannels of 2^{nd} 80 MHz frequency segment, (iii) RA3 for STA3 in 3^{rd} and 4^{th} 20 MHz subchannel of the 2^{nd} 80 MHz frequency segment, (iv) RA4 for a MU-MIMO transmission with 2 users STA1 and STA2 in 3^{rd} 80 MHz frequency segment, and (v) RA5 for STA6 in 4^{th} 80 MHz frequency segment. According to an embodiment, STA5 and STA7 support BW larger than 80 MHz. STA4 and STA5 park in the 1^{st} 80 MHz frequency segment, STA3 and STA7 park in the 2^{nd} 80 MHz frequency segment, STA1 and STA2 park in the 3^{rd} 80 MHz frequency segment and STA6 parks in the 4^{th} frequency segment. In this embodiment, it is noted that STA5 and STA7 have their RU assignments outside their L80s used for EHT modulated fields.

In an embodiment, under Option 2A or Option 2B of MU-MIMO transmission and assuming Option 1 of Common field (with Header subfield), in EHT-SIG CC1 and EHT-SIG CC2 for each 80 MHz frequency segment, Header subfield, RU Allocation subfields and User Specific field can be set as follows:
EHT-SIG CC1:
   Header subfield:
      1^{st} 80 MHz frequency segment: 1000000000000000
      2^{nd} 80 MHz frequency segment: 1000000000000000
      3^{rd} 80 MHz frequency segment: 0000000010000000
      4^{th} 80 MHz frequency segment: 0000000000001000
   RU Allocation subfields (Option 2A)
      1^{st} 80 MHz frequency segment: 102 (RU996 with a single user multiplexed in a MU-MIMO allocation)
      2^{nd} 80 MHz frequency segment: 102 (RU996 with a single user multiplexed in a MU-MIMO allocation)
      3^{rd} 80 MHz frequency segment: 102 (RU996 with a single user multiplexed in a MU-MIMO allocation)
      4^{th} 80 MHz frequency segment: 80 (RU996 with a single user multiplexed in a non-MU-MIMO allocation)
   RU Allocation subfields (Option 2B)
      1^{st} 80 MHz frequency segment: 80 (RU996 with a single user)
      2^{nd} 80 MHz frequency segment: 80 (RU996 with a single user)
      3^{rd} 80 MHz frequency segment: 80 (RU996 with a single user)
      4^{th} 80 MHz frequency segment: 80 (RU996 with a single user)
   User Specific field
      1^{st} 80 MHz frequency segment: user field for STA4
      2^{nd} 80 MHz frequency segment: user field for STA7
      3^{rd} 80 MHz frequency segment: user field for STA1
      4^{th} 80 MHz frequency segment: user field for STA6
EHT-SIG CC2:
   Header subfield:
      1^{st} 80 MHz frequency segment: 0000001000000000
      2^{nd} 80 MHz frequency segment: 0000100000000000
      3^{rd} 80 MHz frequency segment: 0000000010000000
      4^{th} 80 MHz frequency segment: 0000000000001000
   RU Allocation subfields (Option 2A)
      1^{st} 80 MHz frequency segment: 72 (RU484 with a single user multiplexed in a non-MU-MIMO allocation)
      2^{nd} 80 MHz frequency segment: 72 (RU484 with a single user multiplexed in a non-MU-MIMO allocation)
      3^{rd} 80 MHz frequency segment: 102 (RU996 with a single user multiplexed in a MU-MIMO allocation)
      4^{th} 80 MHz frequency segment: 98 (RU996 which contributes zero user fields in CC2)
   RU Allocation subfields (Option 2B)
      1^{st} 80 MHz frequency segment: 72 (RU484 with a single user)
      2^{nd} 80 MHz frequency segment: 72 (RU484 with a single user)
      3^{rd} 80 MHz frequency segment: 80 (RU996 with a single user)
      4^{th} 80 MHz frequency segment: 98 (RU996 which contributes zerouser fields in CC2)
   User Specific field
      1^{st} 80 MHz frequency segment: user field for STA5
      2^{nd} 80 MHz frequency segment: user field for STA3
      3^{rd} 80 MHz frequency segment: user field for STA2
      4^{th} 80 MHz frequency segment: no user field

It is noted that STA4 and STA5 which park in the 1^{st} 80 MHz frequency segment have their RU assignment in the 1^{st} 80 MHz frequency segment and 2^{nd} 80 MHz frequency segment respectively; and STA3 and STA7 which park in the 2^{nd} 80 MHz frequency segment have their RU assignment in the 2nd 80 MHz frequency segment and 1^{st} 80 MHz frequency segment respectively.

According to the present disclosure, STAs parking in different 80 MHz frequency segments e.g. STA4 and STA7 parking in the 1^{st} and 2^{nd} 80 MHz frequency segment respectively, are allowed to be multiplexed in a MU-MIMO transmission if they are capable of receiving the MU-MIMO transmission. In CC1, the Header subfield of CC1 transmitted in the 1^{st} or 2^{nd} 80 MHz frequency segment has bit “1” position in b1 indicating the users or STAs parking in the 1^{st} or 2^{nd} frequency segment, in this case STA4 or STA7, may have their RU assignment information indicated in RU Allocation subfield in the 1^{st} or 2^{nd} 80 MHz frequency segment.

Under Option 2A, according to the example redesigned RU Allocation subfield format under which each RU Allocation subfield in an 80 MHz frequency segment indicates whether a large-size RU or RU combination assignment for a single user is a MU-MIMO allocation or a non-MU-MIMO allocation, the value of 102 in the RU Allocation subfields in CC1 transmitted in each of the 1^{st} and 2^{nd} frequency segments indicates RA1 contributing one single user field, which is multiplexed in a MU-MIMO transmission, to the User Specific field in CC1 transmitted in each of the 1^{st} and 2^{nd} frequency segments, i.e. for STA4 and STA7 respectively. In various embodiments, as STA4 but not STA7 parks in the 1^{st} 80 MHz frequency segment, only the user field corresponding to the STA4 is in the User Specific field transmitted in the 1^{st} 80 MHz frequency segment. Similarly, as STA7 but not STA4 parks in the 2^{nd} 80 MHz frequency field, only the user field corresponding to the STA7 is in the User Specific field transmitted in the 2^{nd} 80 MHz frequency segment.

In CC2, the Header subfield of CC2 transmitted in the 1^{st} or 2^{nd} 80 MHz frequency segment has bit “1” positions in b7 or b5 indicating the users or STAs parking in the 1^{st} or 2^{nd} frequency segment, in this case STA5 or STA3, may have their RU assignment information indicated in RU Allocation subfield in the 1^{st} or 2^{nd} 80 MHz frequency segment. The value of 72 in the RU Allocation subfield in CC2 transmitted in the 1^{st} or 2^{nd} frequency segment indicates RA3 or RA2 contributing one single user field, which is multiplexed in a non-MU-MIMO transmission, to the User Specific field in CC2 transmitted in the 1^{st} or 2^{nd} frequency segment, i.e. for STA5 and STA3.

Additionally, STA1 and STA2 which park in the 3^{rd} 80 MHz frequency segment are allowed to be multiplexed in a MU-MIMO transmission. The Header subfields of CC1 and CC2 transmitted in the 3^{rd} 80 MHz frequency segment both have bit “1” positions in b9 indicating the users or STAs parking in the 3^{rd} 80 MHz frequency segment, i.e. STA1 and STA2, may have their RU assignment information indicated in RU Allocation subfields transmitted in the 3^{rd} 80 MHz frequency segment. The value of 102 in the RU Allocation subfields indicates RA4 contributing one single user field, which is multiplexed in a MU-MIMO transmission, to the User Specific field in each of CC1 and CC2 transmitted in the 3^{rd} 80 MHz frequency segment, i.e. for STA1 and STA2 respectively.

The Header subfields of CC1 and CC2 transmitted in the 4^{th} 80 MHz frequency segment both have bit “1” positions in b13 indicating the user(s) or STA(s) parking in the 4^{th} 80 MHz frequency segment, i.e. STA6, may have its RU assignment information indicated in RU Allocation subfield transmitted in the 4^{th} 80 MHz frequency segment. The value of 80 in the RU Allocation subfield of CC1 indicate RA5 contributing one single user field, which is multiplexed in a non-MU-MIMO transmission, to the User Specific field in CC1 transmitted in the 4^{th} 80 MHz frequency segment.

Under Option 2B, where RU Allocation subfield format defined in Tables 4 to 6 is reused, the value of 80 in the RU Allocation subfields transmitted in the 1^{st} and 2^{nd} 80 MHz frequency segments indicates whether RA1 contributing one single user field to the User Specific field in CC1 transmitted in each of the 1^{st} and 2^{nd} frequency segments, i.e. for STA4 and STA7 respectively. In various embodiments under Option 2B, where the format of a user field is redesigned to include a Format field to indicate whether user field for MU-MIMO allocation or for non-MU-MIMO allocation, as STA4 parks in the 1^{st} 80 MHz frequency segment, only the user field corresponding to the STA4 is in the User Specific field transmitted in the 1^{st} 80 MHz frequency segment. Similarly, as STA7 parks in the 2^{nd} 80 MHz frequency field, only the user field corresponding to the STA7 is in the User Specific field transmitted in the 2^{nd} 80 MHz frequency segment.

In CC2, the Header subfield of CC2 transmitted in the 1^{st} or 2^{nd} 80 MHz frequency segment has bit “1” position in b7 or b5 indicating the users or STAs parking in the 1^{st} or 2^{nd} frequency segment, in this case STA5 or STA3, have their RU assignment information indicated in RU Allocation subfield in the 1^{st} or 2^{nd} 80 MHz frequency segment. The value of 72 in the RU Allocation subfield in CC2 transmitted in the 1^{st} or 2^{nd} frequency segment indicates RA3 or RA2 contributing one user field, which is multiplexed in a non-MU-MIMO transmission, to the User Specific field in CC2 transmitted in the 1^{st} or 2^{nd} frequency segment, i.e. for STA5 or STA3.

Additionally, STA1 and STA2 which park in the 3^{rd} 80 MHz frequency segment are allowed to be multiplexed in a MU-MIMO transmission. The Header subfields of CC1 and CC2 transmitted in the 3^{rd} 80 MHz frequency segment both have bit “1” positions in b9 indicating the users or STAs parking in the 3^{rd} 80 MHz frequency segment, i.e. STA1 and STA2, may have their RU assignment information indicated in RU Allocation subfields transmitted in the 3^{rd} 80 MHz frequency segment. Under Option 2B, the value of 80 in the RU Allocation subfields indicates RA4 contributing one single user field, which is multiplexed in a MU-MIMO transmission, to the User Specific field in each of CC1 and CC2 transmitted in the 3^{rd} 80 MHz frequency segment, i.e. for STA1 and STA2 respectively.

The Header subfields of CC1 and CC2 transmitted in the 4^{th} 80 MHz frequency segment both have bit “1” positions in b13 indicating the user(s) or STA(s) parking in the 4^{th} 80 MHz frequency segment, i.e. STA6, may have its RU assignment information indicated in RU Allocation subfield transmitted in the 4^{th} 80 MHz frequency segment. The value of 80 in the RU Allocation subfield of CC1 indicate RA5 contributing one user field for STA6, which is multiplexed in a non-MU-MIMO transmission, to the User Specific fields in CC1 transmitted in the 4^{th} 80 MHz frequency segment.

Under MU-MIMO Option 2A or Option 2B and assuming Common field Option 2 (without Header subfield), in EHT-SIG CC1 and EHT-SIG CC2 for each 80 MHz frequency segment, RU Allocation subfields and User Specific field can be set as follows:
EHT-SIG CC1
   RU Allocation subfields (Option 2A)
      1^{st} 80 MHz frequency segment: 102 (RU996 with a single user multiplexed in a MU-MIMO allocation), 98 (RU996 which contributes zero user fields in CC1, 97 (RU484 which contributes zero user fields in CC1), 97 (RU484 which contributes zero user fields in CC1), 98 (RU996 which contributes zero user fields in CC1), 98 (RU996 which contributes zero user fields in CC1), 98 (RU996 which contributes zero user fields in CC1), 98 (RU996 which contributes zero user fields in CC1)
      2^{nd} 80 MHz frequency segment: 102 (RU996 with a single user multiplexed in a MU-MIMO allocation), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 98 (RU996 which contributes zero user fields in CC1), 98 (RU996 which contributes zero user fields in CC1)
      3^{rd} 80 MHz frequency segment: 98 (RU996 which contributes zero user fields in CC1), 98 (RU996 which contributes zero user fields in CC1), 97 (RU484 which contributes zero user fields in CC1), 97 (RU484 which contributes zero user fields in CC1), 102 (RU996 with a single user multiplexed in a MU-MIMO allocation), 98 (RU996 which contributes zero user fields in CC1), 98 (RU996 which contributes zero user fields in CC1), 98 (RU996 which contributes zero user fields in CC1)
      4^{th} 80 MHz frequency segment: 98 (RU996 which contributes zero user fields in CC1), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 80 (RU996 with a single user multiplexed in a non-MU-MIMO allocation), 98 (RU996 which contributes zero user fields in CC1)
   RU Allocation subfields (Option 2B)
      1^{st} 80 MHz frequency segment: 80 (RU996 with a single user), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 98 (RU996 which contributes zero user fields in CC1), 98 (RU996 which contributes zero user fields in CC1)
      2^{nd} 80 MHz frequency segment: 80 (RU996 with a single user), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 98 (RU996 which contributes zero user fields in CC1), 98 (RU996 which contributes zero user fields in CC1)
      3^{rd} 80 MHz frequency segment: 98 (RU996 which contributes zero user fields in CC1), 98 (RU996 which contributes zero user fields in CC1), 97 (RU484 which contributes zero user fields in CC1), 97 (RU484 which contributes zero user fields in CC1), 80 (RU996 with a single user), 98 (RU996 which contributes zero user fields in CC1), 98 (RU996 which contributes zero user fields in CC1), 98 (RU996 which contributes zero user fields in CC1)
      4^{th} 80 MHz frequency segment: 98 (RU996 which contributes zero user fields in CC1), 98 (RU996 which contributes zero user fields in CC1), 97 (RU484 which contributes zero user fields in CC1), 97 (RU484 which contributes zero user fields in CC1), 98 (RU996 which contributes zero user fields in CC1), 98 (RU996 which contributes zero user fields in CC1), 80 (RU996 with a single user), 98 (RU996 which contributes zero user fields in CC1)
   User Specific field
      1^{st} 80 MHz frequency segment: user field for STA4
      2^{nd} 80 MHz frequency segment: user field for STA7
      3^{rd} 80 MHz frequency segment: user field for STA1
      4^{th} 80 MHz frequency segment: user field for STA6
EHT-SIG CC2:
   RU Allocation subfields (Option 2A)
      1^{st} 80 MHz frequency segment: 98 (RU996 which contributes zero user fields in CC2), 98 (RU996 which contributes zero user fields in CC2), 97 (RU484 which contributes zero user fields in CC2), 72 (RU484 with a single user multiplexed in a non-MU-MIMO allocation), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
      2^{nd} 80 MHz frequency segment: 98 (RU996 which contributes zero user fields in CC2), 98 (RU996 which contributes zero user fields in CC2), 72 (RU484 with a single user multiplexed in a non-MU-MIMO allocation), 97 (RU484 which contributes zero user fields in CC2), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
      3^{rd} 80 MHz frequency segment: 98 (RU996 which contributes zero user fields in CC2), 98 (RU996 which contributes zero user fields in CC2), 97 (RU484 which contributes zero user fields in CC2), 97 (RU484 which contributes zero user fields in CC2), 102 (RU996 with a single user multiplexed in a MU-MIMO allocation), 98 (RU996 which contributes zero user fields in CC2), 98 (RU996 which contributes zero user fields in CC2), 98 (RU996 which contributes zero user fields in CC2)
      4^{th} 80 MHz freauencv segment: 98 (RU996 which contributes zero user fields in CC2), 98 (RU996 which contributes zero user fields in CC2), 97 (RU484 which contributes zero user fields in CC2), 97 (RU484 which contributes zero user fields in CC2), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
   RU Allocation subfields (Option 2B)
      1^{st} 80 MHz frequency segment: 98 (RU996 which contributes zero user fields in CC2), 98 (RU996 which contributes zero user fields in CC2), 97 (RU484 which contributes zero user fields in CC2), 72 (RU484 with a single user), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
      2^{nd} 80 MHz frequency segment: 98 (RU996 which contributes zero user fields in CC2), 98 (RU996 which contributes zero user fields in CC2), 72( RU484 with a single user), 97 (RU484 which contributes zero user fields in CC2), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
      3^{rd} 80 MHz frequency segment: 98 (RU996 which contributes zero user fields in CC2), 98 (RU996 which contributes zero user fields in CC2), 97 (RU484 which contributes zero user fields in CC2), 97 (RU484 which contributes zero user fields in CC2), 80 (RU996 with a single user), 98 (RU996 which contributes zero user fields in CC2), 98 (RU996 which contributes zero user fields in CC2), 98 (RU996 which contributes zero user fields in CC2)
      4^{th} 80 MHz frequency segment: 98 (RU996 which contributes zero user fields in CC2), 98 (RU996 which contributes zero user fields in CC2), 97 (RU484 which contributes zero user fields in CC2), 97 (RU484 which contributes zero user fields in CC2), 98 (RU996 which contributes zero user fields in CC2), 98 (RU996 which contributes zero user fields in CC2), 98 (RU996 which contributes zero user fields in CC2), 98 (RU996 which contributes zero user fields in CC2)
   User Specific field
      1^{st} 80 MHz frequency segment: user field for STA5
      2^{nd} 80 MHz frequency segment: user field for STA3
      3^{rd} 80 MHz frequency segment: user field for STA2
      4^{th} 80 MHz frequency segment: no user field

Under Option 2A, according to the redesigned RU Allocation subfield format in which each RU Allocation subfield in an 80 MHz frequency segment indicates whether a large-size RU or RU combination assignment for a single user is a MU-MIMO allocation or a non-MU-MIMO allocation, the RU Allocation subfields of CC1 transmitted in the 1^{st} and 2^{nd} 80 MHz frequency segments have a value of 102 at a placement corresponding to RA1 (1^{st} RU Allocation subfield value). This indicates that the users or STAs parking in the 1^{st} or 2^{nd} 80 MHz frequency segments, in this case STA4 or STA7, may have their RU assignment information indicated in the 1^{st} or 2^{nd} 80 MHz frequency segment. The value of 102 indicates RA1 contributing one single user field, which is multiplexed in a MU-MIMO transmission, to the User Specific field in CC1 transmitted in each of the 1^{st} and 2^{nd} frequency segments, i.e. for STA4 and STA7. In various embodiments, as STA4 but not STA7 parks in the 1^{st} 80 MHz frequency segment, only the user field corresponding to the STA4 is in the User Specific field transmitted in the 1^{st} 80 MHz frequency segment. Similarly, as STA7 but not STA4 parks in the 2^{nd} 80 MHz frequency field, only the user field corresponding to the STA7 is in the User Specific field transmitted in the 2^{nd} 80 MHz frequency segment.

In CC2, the RU Allocation subfields of CC2 transmitted in the 1^{st} and 2^{nd} 80 MHz frequency segments have a value of 72 at a placement corresponding to RA3 and RA2 (4^{th} and 3^{rd} RU Allocation subfield value respectively). This indicates that the users or STAs parking in the 1^{st} or 2^{nd} 80 MHz frequency segment, in this case STA5 or STA3, have their RU assignment information indicated in the 1^{st} or 2^{nd} 80 MHz frequency segment. The value of 72 indicates RA3 or RA2 contributing one single user field, which is multiplexed in a non-MU-MIMO transmission, to the User Specific field in CC2 transmitted in the 1^{st} or 2^{nd} frequency segment, i.e. for STA5 or STA3.

The RU Allocation subfields of CC1 and CC2 transmitted in the 3^{rd} 80 MHz frequency segment have a value of 102 at placement corresponding to RA4 (5^{th} RU Allocation subfield value in both CC1 and CC2). This indicates that the users or STAs parking in the 3^{rd} 80 MHz frequency segment, i.e. STA1 and STA2, may have their RU assignment information indicated in the 3^{rd} 80 MHz frequency segment. The value of 102 in the RU Allocation subfields indicates RA4 contributing one single user field, which is multiplexed in a MU-MIMO transmission, to the User Specific field in each of CC1 and CC2 transmitted in the 3^{rd} 80 MHz frequency segment, i.e. for STA1 and STA2 respectively.

The RU Allocation subfields of CC1 transmitted in the 4^{th} 80 MHz frequency segment have a value of 80 at placement corresponding to RA5 (7^{th} RU Allocation subfield value in both CC1 and CC2). This indicates that the users or STAs parking in the 4^{th} 80 MHz frequency segment, i.e. STA6, may have their RU assignment information indicated in the 4^{th} 80 MHz frequency segment. The value of 80 in the RU Allocation subfield in CC1 indicates RA5 contributing one user field, which is multiplexed in a non-MU-MIMO transmission, to the User Specific field in the CC1 transmitted in the 4^{th} 80 MHz frequency segment, i.e. for STA6.

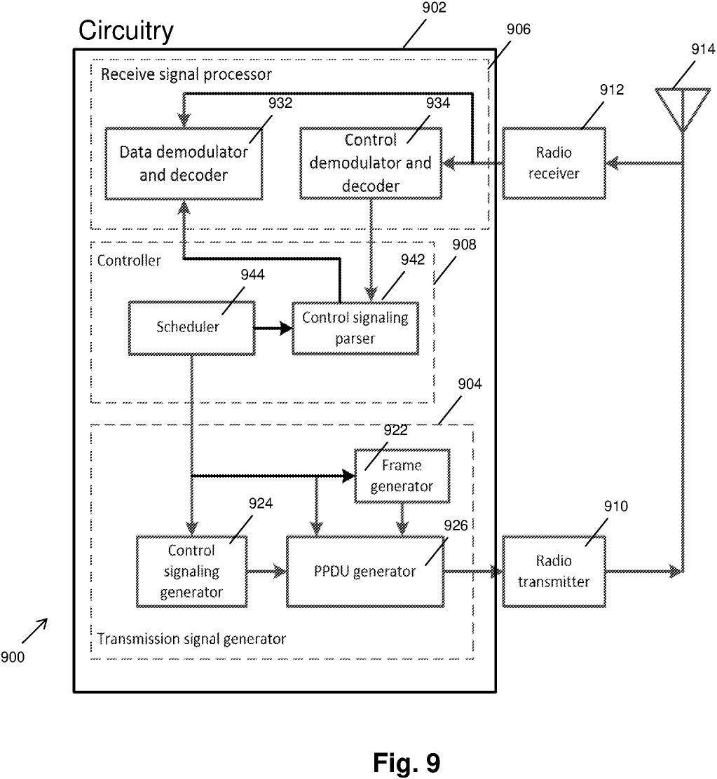

FIG. 9 shows a configuration of a communication device 900, for example an AP according to various embodiments. Similar to the schematic example of the communication apparatus 600 shown in FIG. 6, the communication apparatus 900 includes circuitry 902, at least 914 radio transmitter 910, at least one radio receiver 912, at least one antenna 914 (for the sake of simplicity, only one antenna is depicted in FIG. 9). The circuitry 902 may include at least one controller 908 for use in software and hardware aided execution of tasks that the controller 908 is designed to perform OFDMA or non-OFDMA communications. The circuitry 902 may further include a transmission signal generator 904 and a receive signal processor 906. The at least one controller 908 may control the transmission signal generator 904 and the receive signal processor 906. The transmission signal generator 904 may include a frame generator 922, a control signaling generator 924, and a PPDU generator 926. The frame generator 922 may generate MAC frames, e.g. data frames or triggering frames. The control signaling generator 924 may generate control signaling fields of PPDUs to be generated (e.g. U-SIG fields and EHT-SIG fields of EHT basic PPDUs). The PPDU generator 926 may generate PPDUs (e.g. EHT basic PPDUs).

The receive signal processor 906 may include a data demodulator and decoder 934, which may demodulate and decode data portions of the received signals (e.g. data fields of EHT basic PPDUs). The receive signal processor 906 may further include a control demodulator and decoder 934, which may demodulate and decode control signaling portions of the received signals (e.g. U-SIG fields and EHT-SIG fields of EHT basic PPDUs). The at least one controller 908 may include a control signal parser 942 and a scheduler 944. The scheduler 944 may determine RU information and user-specific allocation information for allocations of downlink SU or MU transmissions and triggering information for allocations of uplink MU transmissions. The control signal parser 942 may analyse the control signaling portions of the received signals and the triggering information for allocations of uplink MU transmissions shared by the scheduler 944 and assist the data demodulator and decoder 932 in demodulating and decoding the data portions of the received signals.

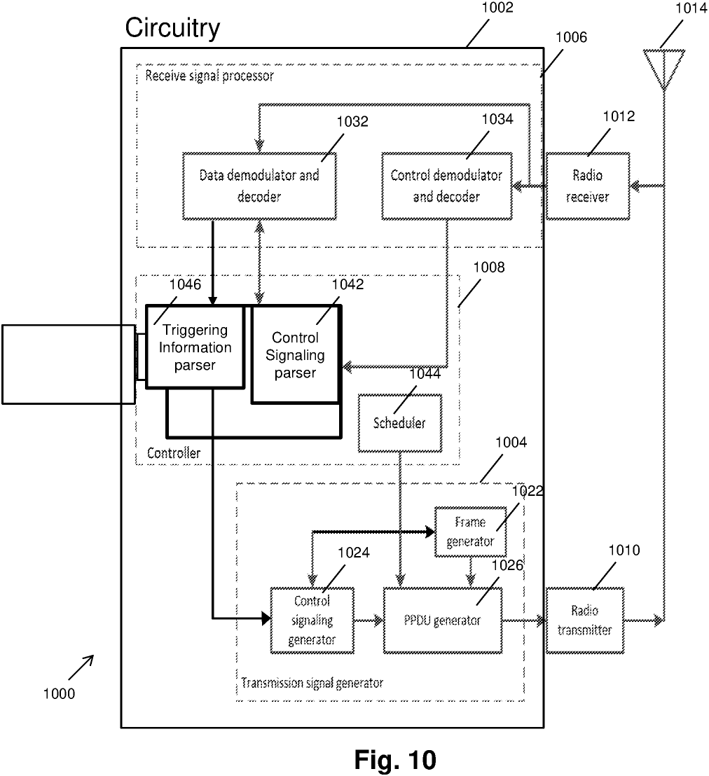

FIG. 10 shows a configuration of a communication apparatus 1000, for example a STA according to various embodiments. Similar to the schematic example of communication apparatus 600 shown in FIG. 6, the communication apparatus 1000 includes circuitry 1002, at least one radio transmitter 1010, at least one radio receiver 1012, at least one antenna 1014 (for the sake of simplicity, only one antenna is depicted in FIG. 10). The circuitry 1002 may include at least one controller 1008 for use in software and hardware aided execution of tasks that the controller 1008 is designed to perform OFDMA or non-OFDMA communications. The circuitry 1002 may further include a receive signal processor 1004 and a transmission signal generator 1006. The at least one controller 1008 may control the receive signal processor 1004 and the transmission signal generator 1006. The receive signal processor 1004 may include a data demodulator and decoder 1032 and a control demodulator and decoder 1034. The control demodulator and decoder 1034 may demodulate and decode control signaling portions of the received signals (e.g. U-SIG fields and EHT-SIG fields of EHT basic PPDUs). The data demodulator and decoder 1032 may demodulate and decode data portions of the received signals (e.g. data fields of ETH basic PPDUs) according to RU information and user-specific allocation information of its own allocations.

The at least one controller 1008 may include a control signal parser 1042, and a scheduler 1044 and a trigger information parser 1046. The control signal parser 1042 may analyse the control signaling portions of the received signals (e.g. U-SIG fields and EHT-SIG fields of EHT basic PPDUs) and assist the data demodulator and decoder 1032 in demodulating and decoding the data portions of the received signals (e.g. data fields of EHT basic PPDUs). The triggering information parser 1048 may analyse the triggering information for its own uplink allocations from the received triggering frames contained in the data portions of the received signals. The transmission signal generator 1004 may include a control signaling generator 1024, which may generate control signaling fields of PPDUs to be generated (e.g. U-SIG fields of EHT basic PPDUs). The transmission signal generator 1004 may further include a PPDU generator 1026, which generate PPDUs (e.g. EHT basic PPDUs). The transmission signal generator 1004 may further include a frame generator 1022 may generate MAC frames, e.g. data frames.

As described above, the embodiments of the present disclosure provide an advanced communication system, communication methods and communication apparatuses for MU-MIMO transmissions in WLAN networks of an extremely high throughput and improve spectral efficiency in MIMO WLAN networks.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (loT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

TABLE 4

RU subfield values corresponding to assignments of small-size RU according to an embodiment

| | | | | | | | | | | |
|---|---|---|---|---|---|---|---|---|---|---|
| B7....B1B0 | #1 | #2 | #3 | #4 | #5 | #6 | #7 | #8 | #9 | # of Entries |
| 0 (“00000000”) | 26 | 26 | 26 | 26 | 26 | 26 | 26 | 26 | 26 | 1 |
| 1 (“00000001”) | 26 | 26 | 26 | 26 | 26 | 26 | 26 | 52 | | 1 |
| 2 (“00000010”) | 26 | 26 | 26 | 26 | 26 | 52 | | 26 | 26 | 1 |
| 3 (“00000011”) | 26 | 26 | 26 | 26 | 26 | 52 | | 52 | | 1 |
| 4 (“00000100”) | 26 | 26 | 52 | | 26 | 26 | 26 | 26 | 26 | 1 |
| 5 (“00000101”) | 26 | 26 | 52 | | 26 | 26 | 26 | 52 | | 1 |
| 6 (“00000110”) | 26 | 26 | 52 | | 26 | 52 | | 26 | 26 | 1 |
| 7 (“00000111”) | 26 | 26 | 52 | | 26 | 52 | | 52 | | 1 |
| 8 (“00001000”) | 52 | | 26 | 26 | 26 | 26 | 26 | 26 | 26 | 1 |
| 9 (“00001001”) | 52 | | 26 | 26 | 26 | 26 | 26 | 52 | | 1 |
| 10 (“00001010”) | 52 | | 26 | 26 | 26 | 52 | | 26 | 26 | 1 |
| 11 (“00001011”) | 52 | | 26 | 26 | 26 | 52 | | 52 | | 1 |
| 12 (“00001100”) | 52 | | 52 | | 26 | 26 | 26 | 26 | 26 | 1 |
| 13 (“00001101”) | 52 | | 52 | | 26 | 26 | 26 | 52 | | 1 |
| 14 (“00001110”) | 52 | | 52 | | 26 | 52 | | 26 | 26 | 1 |
| 15 (“00001111”) | 52 | | 52 | | 26 | 52 | | 52 | | 1 |
| 16 (“00010000”) | 26 | 26 | 26 | 26 | 26 | 106 | | | | 1 |
| 17 (“00010001”) | 26 | 26 | 52 | | 26 | 106 | | | | 1 |
| 18 (“00010010”) | 52 | | 26 | 26 | 26 | 106 | | | | 1 |
| 19 (“00010011”) | 52 | | 52 | | 26 | 106 | | | | 1 |
| 20 (“00010100”) | 106 | | | | 26 | 26 | 26 | 26 | 26 | 1 |
| 21 (“00010101”) | 106 | | | | 26 | 26 | 26 | 52 | | 1 |
| 22 (“00010110”) | 106 | | | | 26 | 26 | 26 | 52 | 26 | 1 |
| 23 (“00010111”) | 106 | | | | 26 | 52 | | 52 | | 1 |
| 24 (“00011000”) | 52 | | 52 | | - | 52 | | 52 | | 1 |
| 25 (“00011001”) | 106 | | | | 26 | 106 | | | | 1 |
| 26^{~}31 (“00011010”^{~}“00011111”) | reserved | | | | | | | | | 7 |

TABLE 5

RU subfield values corresponding to assignment of small-size RU combinations and large-size RUs according to an embodiment

| | | | | | | | | | | |
|---|---|---|---|---|---|---|---|---|---|---|
| B7....B1B0 | #1 | #2 | #3 | #4 | #5 | #6 | #7 | #8 | #9 | # of Entries |
| 32 (“00100000”) | 26 | 78 | | | 26 | 26 | 26 | 26 | 26 | 1 |
| 33 (“00100001”) | 26 | 78 | | | 26 | 26 | 26 | 52 | | 1 |
| 34 (“00100010”) | 26 | 78 | | | 26 | 52 | | 26 | 26 | 1 |
| 35 (“00100011”) | 26 | 78 | | | 26 | 52 | | 52 | | 1 |
| 36 (“00100100”) | 26 | 26 | 26 | 26 | 26 | 78 | | | 26 | 1 |
| 37 (“00100101”) | 52 | | 26 | 26 | 26 | 78 | | | 26 | 1 |
| 38 (“00100110”) | 26 | 26 | 52 | | 26 | 78 | | | 26 | 1 |
| 39 (“00100111”) | 52 | | 52 | | 26 | 78 | | | 26 | 1 |
| 40 (“00101000”) | 26 | 78 | | | 26 | 78 | | | 26 | 1 |
| 41 (“00101001”) | 26 | 78 | | | 26 | 106 | | | | 1 |
| 42 (“00101010”) | 106 | | | | 26 | 78 | | | 26 | 1 |
| 43 (“00101011”) | 132 | | | | | 26 | 26 | 26 | 26 | 1 |
| 44 (“00101100”) | 132 | | | | | 26 | 26 | 52 | | 1 |
| 45 (“00101101”) | 132 | | | | | 52 | | 26 | 26 | 1 |
| 46 (“00101110”) | 132 | | | | | 52 | | 52 | | 1 |
| 47 (“00101111”) | 26 | 26 | 26 | 26 | 132 | | | | | 1 |
| 48 (“00110000”) | 52 | | 26 | 26 | 132 | | | | | 1 |
| 49 (“00110001”) | 26 | 26 | 52 | | 132 | | | | | 1 |
| 50 (“00110010”) | 52 | | 52 | | 132 | | | | | 1 |
| 51 (“00110011”) | 26 | | 78 | | 132 | | | | | 1 |
| 52 (“00110100”) | 132 | | | | | 78 | | | 26 | 1 |
| 53 (“00110101”) | 132 | | | | | 106 | | | | 1 |
| 54 (“00110110”) | 106 | | | | 132 | | | | | 1 |
| 55 ^{~} 63 (“00110111”-“00111111”) | reserved | | | | | | | | | 9 |
| 64^{~} 71 (“01000y2y1y0”) | 242 | | | | | | | | | 8 |

TABLE 5 (cont.)

| | | | | | | | | | | |
|---|---|---|---|---|---|---|---|---|---|---|
| B7....B1B0 | #1 | #2 | #3 | #4 | #5 | #6 | #7 | #8 | #9 | # of Entries |
| 72^{~} 79 (“01001y2y1y0”) | 484 | | | | | | | | | 8 |
| 80^{~} 87 (“01010y2y1y0”) | 996 | | | | | | | | | 8 |
| 88^{~} 95 (“01011y2y1y0”) | 2×996 | | | | | | | | | 8 |
| 96 (“01100000”) | 242-tone RU empty (with zero users) | | | | | | | | | 1 |
| 97 (“01100001”) | 484-tone RU; contributes zero user fields to User Specific field in the same EHT-SIG content channel as this RU Allocation subfield | | | | | | | | | 1 |
| 98 (“01100010”) | 996-tone RU; contributes zero user fields to User Specific field in the same EHT-SIG content channel as this RU Allocation subfield | | | | | | | | | 1 |
| 99 (“01100011”) | 2×996-tone RU; contributes zero user fields to User Specific field in the same EHT-SIG content channel as this RU Allocation subfield | | | | | | | | | 1 |

TABLE 6

RU subfield value corresponding to assignments of large-size RU combinations according to an embodiment

| | | | | | | | | | | |
|---|---|---|---|---|---|---|---|---|---|---|
| B7....B1B0 | #1 | #2 | #3 | #4 | #5 | #6 | #7 | #8 | #9 | # of Entries |
| 100^{~}127 (“01100100”^{~}“01111111”) | reserved | | | | | | | | | 28 |
| 128⁻135 (“10000y2y1y0”) | 1^{ST} 242-tone RU +2^{nd} 484-tone RU in an 80 MHz frequency segment | | | | | | | | | 8 |
| 136^{~}143 (“10001y2y1y0”) | 2^{nd} 242-tone RU +2^{nd} 484-tone RU in an 80 MHz frequency segment | | | | | | | | | 8 |
| 144^{~}151 (“10010y2y1y0”) | 1^{st} 484-tone RU +3^{rd} 242-tone RU in an 80 MHz frequency segment | | | | | | | | | 8 |
| 152^{~}159 (“10011y2y1y0”) | 1^{st} 484-tone RU +4^{th} 242-tone RU in an 80 MHz frequency segment | | | | | | | | | 8 |
| 160^{~}167 (“10100y2y1y0”) | 1^{ST} 484-tone RU +2^{nd} 996-tone RU in a 160 MHz frequency segment | | | | | | | | | 8 |
| 168^{~}175 (“10101y2y1y0”) | 2^{nd} 484-tone RU +2^{nd} 996-tone RU in a 160 MHz frequency segment | | | | | | | | | 8 |
| 176^{~}183 (“10110y2y1y0”) | 1^{st} 996-tone RU +3^{rd} 484-tone RU in a 160 MHz frequency segment | | | | | | | | | 8 |
| 184^{~}191 (“10111y2y1y0”) | 1^{st} 996-tone RU +4^{th} 484-tone RU in a 160 MHz frequency segment | | | | | | | | | 8 |
| 192^{~}199 (“11000y2y1y0”) | 1^{st} 996-tone RU+2^{nd} 996-tone RU+3^{rd} 996-tone RU in a 320 MHz frequency segment | | | | | | | | | 8 |
| 200^{~}207 (“11001y2y1y0”) | 1^{st} 996-tone RU+3^{rd} 996-tone RU+4^{th} 996-tone RU in a 320 MHz frequency segment | | | | | | | | | 8 |
| 208^{~} (“11010y2y1y0”) | 2^{nd} 996-tone RU+3^{rd} 996-tone RU+4^{th} 996-tone RU in a 320 MHz frequency segment | | | | | | | | | 8 |
| 216^{~}223 (“11011y2y1y0”) | 1^{st} 996-tone RU+2^{nd} 996-tone RU+4^{th} 996-tone RU in a 320 MHz frequency segment | | | | | | | | | 8 |
| 224 (“11100000”) | 1^{ST} 242-tone RU +2^{nd} 484-tone RU in an 80 MHz frequency segment; contributes zero user fields to User Specific field in the same EHT-SIG content channel as this RU Allocation subfield | | | | | | | | | 1 |
| 225 (“11100001”) | 2^{nd} 242-tone RU +2^{nd} 484-tone RU in an 80 MHz frequency segment; contributes zero user fields to User Specific field in the same EHT-SIG content channel as this RU Allocation subfield | | | | | | | | | 1 |
| 226 (“11100010”) | 1^{st} 484-tone RU +3^{rd} 242-tone RU in an 80 MHz frequency segment; contributes zero user fields to User Specific field in the same EHT-SIG content channel as this RU Allocation subfield | | | | | | | | | 1 |
| 227 (“11100011”) | 1^{st} 484-tone RU +4^{th} 242-tone RU in an 80 MHz frequency segment; contributes zero user fields to User Specific field in the same EHT-SIG content channel as this RU Allocation subfield | | | | | | | | | 1 |
| 228 (“11100100”) | 1^{ST} 484-tone RU +2^{nd} 996-tone RU in a 160 MHz frequency segment; contributes zero user fields to User Specific field in the same EHT-SIG content channel as this RU Allocation subfield | | | | | | | | | 1 |

TABLE 6 (cont.)

| | | | | | | | | | | |
|---|---|---|---|---|---|---|---|---|---|---|
| B7....B1B0 | #1 | #2 | #3 | #4 | #5 | #6 | #7 | #8 | #9 | # of Entries |
| 229 (“11100101”) | 2^{nd} 484-tone RU +2^{nd} 996-tone RU in a 160 MHz frequency segment; contributes zero user fields to User Specific field in the same EHT-SIG content channel as this RU Allocation subfield | | | | | | | | | 1 |
| 230 (“11100110”) | 1^{st} 996-tone RU +3^{rd} 484-tone RU in a 160 MHz frequency segment; contributes zero user fields to User Specific field in the same EHT-SIG content channel as this RU Allocation subfield | | | | | | | | | 1 |
| 231 (“11100111”) | 1^{st} 996-tone RU +4^{th} 484-tone RU in a 160 MHz frequency segment; contributes zero user fields to User Specific field in the same EHT-SIG content channel as this RU Allocation subfield | | | | | | | | | 1 |
| 232 (“11101000”) | 1^{st} 996-tone RU+2^{nd} 996-tone RU+3^{rd} 996-tone RU in a 320 MHz frequency segment; contributes zero user fields to User Specific field in the same EHT-SIG content channel as this RU Allocation subfield | | | | | | | | | 1 |
| 233 (“11101001”) | 1^{st} 996-tone RU+3^{rd} 996-tone RU+4^{th} 996-tone RU in a 320 MHz frequency segment; contributes zero user fields to User Specific field in the same EHT-SIG content channel as this RU Allocation subfield | | | | | | | | | 1 |
| 234 (“11101010”) | 2^{nd} 996-tone RU+3^{rd} 996-tone RU+4^{th} 996-tone RU in a 320 MHz frequency segment; contributes zero user fields to User Specific field in the same EHT-SIG content channel as this RU Allocation subfield | | | | | | | | | 1 |
| 235 (“11101011”) | 1^{st} 996-tone RU+2^{nd} 996-tone RU+4^{th} 996-tone RU in a 320 MHz frequency segment; contributes zero user fields to User Specific field in the same EHT-SIG content channel as this RU Allocation subfield | | | | | | | | | 1 |
| 236^{~}255 (“11101100”^{~}“11111111”) | reserved | | | | | | | | | 20 |

TABLE 7

RU Allocation subfield with information on whether a large-size RU or RU combination assignment for a single user is a MU-MIMO allocation or a non-MU-MIMO allocation

| | | | | | | | | | | |
|---|---|---|---|---|---|---|---|---|---|---|
| B7....B1B0 | #1 | #2 | #3 | #4 | #5 | #6 | #7 | #8 | #9 | # of Entries |
| 100 (“01100100”) | 242 (MU-MIMO with single user) | | | | | | | | | 1 |
| 101 (“01100101”) | 484 (MU-MIMO with single user) | | | | | | | | | 1 |
| 102 (“01100110”) | 996 (MU-MIMO with single user) | | | | | | | | | 1 |
| 103 (“01100111”) | 2*996 (MU-MIMO with single user) | | | | | | | | | 1 |
| 104^{~}127 (“01101000”^{~}“01111111”) | Reserved | | | | | | | | | 24 |
| 128^{~} 135 (“10000y2y1y0”) | 1^{ST} 242-tone RU +2^{nd} 484-tone RU in an 80 MHz frequency segment | | | | | | | | | 8 |
| ... | ... | | | | | | | | | ... |
| 216^{~} 223 (“11011y2y1y0”) | 1^{st} 996-tone RU+2^{nd} 996-tone RU+4^{th} 996-tone RU in a 320 MHz frequency segment | | | | | | | | | 8 |
| 224 (“11100000”) | 1^{ST} 242-tone RU +2^{nd} 484-tone RU in an 80 MHz frequency segment; contributes zero user fields to User Specific field in the same EHT-SIG content channel as this RU Allocation subfield | | | | | | | | | 1 |
| ... | ... | | | | | | | | | ... |
| 235 (“11101011”) | 1^{st} 996-tone RU+2^{nd} 996-tone RU+4^{th} 996-tone RU in a 320 MHz frequency segment; contributes zero user fields to User Specific field in the same EHT-SIG content channel as this RU Allocation subfield | | | | | | | | | 1 |
| 236 (“11101100”) | 1^{ST} 242-tone RU +2^{nd} 484-tone RU in an 80 MHz frequency segment (MU-MIMO with single user) | | | | | | | | | 1 |
| 237 (“11101101”) | 2^{nd} 242-tone RU +2^{nd} 484-tone RU in an 80 MHz frequency segment (MU-MIMO with single user) | | | | | | | | | 1 |
| 238 (“11101110”) | 1^{st} 484-tone RU +3^{rd} 242-tone RU in an 80 MHz frequency segment (MU-MIMO with single user) | | | | | | | | | 1 |
| 239 (“11101111”) | 1^{st} 484-tone RU +4^{th} 242-tone RU in an 80 MHz frequency segment (MU-MIMO with single user) | | | | | | | | | 1 |
| 240 (“11110000”) | 1^{ST} 484-tone RU +2^{nd} 996-tone RU in a 160 MHz frequency segment (MU-MIMO with single user) | | | | | | | | | 1 |
| 241 (“11110001”) | 2^{nd} 484-tone RU +2^{nd} 996-tone RU in a 160 MHz frequency segment (MU-MIMO with single user) | | | | | | | | | 1 |
| 242 (“11110010”) | 1^{st} 996-tone RU +3^{rd} 484-tone RU in a 160 MHz frequency segment (MU-MIMO with single user) | | | | | | | | | 1 |
| 243 (“11110011”) | 1^{st} 996-tone RU +4^{th} 484-tone RU in a 160 MHz frequency segment (MU-MIMO with single user) | | | | | | | | | 1 |

TABLE 7 (cont.)

| | | | | | | | | | | |
|---|---|---|---|---|---|---|---|---|---|---|
| B7....B1B0 | #1 | 2 | #3 | #4 | #5 | #6 | #7 | #8 | #9 | # of Entries |
| 244 (“11110100”) | 1^{st} 996-tone RU+2^{nd} 996-tone RU+3^{rd} 996-tone RU in a 320 MHz frequency segment (MU-MIMO with single user) | | | | | | | | | 1 |
| 245 (“11110101”) | 1^{st} 996-tone RU+3^{rd} 996-tone RU+4^{th} 996-tone RU in a 320 MHz frequency segment (MU-MIMO with single user) | | | | | | | | | 1 |
| 246 (“11110110”) | 2^{nd} 996-tone RU+3^{rd} 996-tone RU+4^{th} 996-tone RU in a 320 MHz frequency segment (MU-MIMO with single user) | | | | | | | | | 1 |
| 247 (“11110111”) | 1^{st} 996-tone RU+2^{nd} 996-tone RU+4^{th} 996-tone RU in a 320 MHz frequency segment (MU-MIMO with single user) | | | | | | | | | 1 |
| 248^{~}255 (“11111000^{~}11111111”) | reserved | | | | | | | | | 8 |

TABLE 8

Spatial configuration indices when the number of users is 2 or 3 according to an embodiment

| Nᵤₛₑᵣ | Spatial Configuration Index | N_{STS}[1] | N_{STS}[2] | N_{STS}[3] | Total N_{STS} |
|---|---|---|---|---|---|
| 2 | 0-3 | 1-4 | 1 | | 2-5 |
| | 4-6 | 2-4 | 2 | | 4-6 |
| | 7-8 | 3-4 | 3 | | 6-7 |
| | 9 | 4 | 4 | | 8 |
| 3 | 0-3 | 1-4 | 1 | 1 | 3-6 |
| | 4-6 | 2-4 | 2 | 1 | 5-7 |
| | 7-8 | 3-4 | 3 | 1 | 7-8 |
| | 9 | 4 | 4 | 1 | 9 |
| | 10-12 | 2-4 | 2 | 2 | 6-8 |
| | 13-14 | 3-4 | 3 | 2 | 8-9 |
| | 15 | 4 | 4 | 2 | 10 |
| | 16-17 | 3-4 | 3 | 3 | 9-10 |
| | 18 | 4 | 4 | 3 | 11 |
| | 19 | 4 | 4 | 4 | 12 |

TABLE 9

Spatial configuration indices when the number of users is 4 according to an embodiment

| Nᵤₛₑᵣ | Spatial Configuration Index | N_{STS}[1] | Nsrs[2] | N_{STS}[3] | N_{STS}[4] | Total N_{STS} |
|---|---|---|---|---|---|---|
| 4 | 0-3 | 1-4 | 1 | 1 | 1 | 4-7 |
| | 4-6 | 2-4 | 2 | 1 | 1 | 6-8 |
| | 7-8 | 3-4 | 3 | 1 | 1 | 8-9 |
| | 9 | 4 | 4 | 1 | 1 | 10 |
| | 10-12 | 2-4 | 2 | 2 | 1 | 7-9 |
| | 13-14 | 3-4 | 3 | 2 | 1 | 9-10 |
| | 15 | 4 | 4 | 2 | 1 | 11 |
| | 16-17 | 3-4 | 3 | 3 | 1 | 10-11 |
| | 18 | 4 | 4 | 3 | 1 | 12 |
| | 19 | 4 | 4 | 4 | 1 | 13 |
| | 20-22 | 2-4 | 2 | 2 | 2 | 8-10 |
| | 23-24 | 3-4 | 3 | 2 | 2 | 10-11 |
| | 25 | 4 | 4 | 2 | 2 | 12 |
| | 26-27 | 3-4 | 3 | 3 | 2 | 11-12 |
| | 28 | 4 | 4 | 3 | 2 | 13 |
| | 29 | 4 | 4 | 4 | 2 | 14 |
| | 30-31 | 3-4 | 3 | 3 | 3 | 12-13 |
| | 32 | 4 | 4 | 4 | 3 | 15 |
| | 33 | 4 | 4 | 4 | 4 | 16 |

TABLE 10

Spatial configuration indices when the number of users is 5 according to an embodiment

| Nᵤₛₑᵣ | Spatial Configuration Index | N_{STS}[1] | N_{STS}[2] | N_{STS}[3] | N_{STS}[4] | N_{STS}[5] | Total N_{STS} |
|---|---|---|---|---|---|---|---|
| 5 | 0-3 | 1-4 | 1 | 1 | 1 | 1 | 5-8 |
| | 4-6 | 2-4 | 2 | 1 | 1 | 1 | 7-9 |
| | 7-8 | 3-4 | 3 | 1 | 1 | 1 | 9-10 |
| | 9 | 4 | 4 | 1 | 1 | 1 | 11 |
| | 10-12 | 2-4 | 2 | 2 | 1 | 1 | 8-10 |
| | 13-14 | 3-4 | 3 | 2 | 1 | 1 | 10-11 |
| | 15 | 4 | 4 | 2 | 1 | 1 | 12 |
| | 16-17 | 3-4 | 3 | 3 | 1 | 1 | 11-12 |
| | 18 | 4 | 4 | 3 | 1 | 1 | 13 |
| | 19 | 4 | 4 | 4 | 1 | 1 | 14 |
| | 20-22 | 2-4 | 2 | 2 | 2 | 1 | 9-11 |
| | 23-24 | 3-4 | 3 | 2 | 2 | 1 | 11-12 |
| | 25 | 4 | 4 | 2 | 2 | 1 | 13 |
| | 26-27 | 3-4 | 3 | 3 | 2 | 1 | 12-14 |
| | 28 | 4 | 4 | 3 | 2 | 1 | 14 |
| | 29-30 | 3-4 | 3 | 3 | 3 | 1 | 13-14 |
| | 31-33 | 2-4 | 2 | 2 | 2 | 2 | 10-12 |
| | 34-35 | 3-4 | 3 | 3 | 3 | 2 | 14-15 |
| | 36-37 | 3-4 | 3 | 3 | 3 | 3 | 15-16 |

TABLE 11

Spatial configuration indices when the number of users is 6 according to an embodiment

| Nᵤₛₑᵣ | Spatial Configuration Index | N_{STS}[1] | N_{STS}[2] | N_{STS}[3] | N_{STS}[4] | N_{STS}[5] | N_{STS}[6] | Total N_{STS} |
|---|---|---|---|---|---|---|---|---|
| 6 | 0-3 | 1-4 | 1 | 1 | 1 | 1 | 1 | 6-9 |
| | 4-6 | 2-4 | 2 | 1 | 1 | 1 | 1 | 8-10 |
| | 7-8 | 3-4 | 3 | 1 | 1 | 1 | 1 | 10-11 |
| | 9 | 4 | 4 | 1 | 1 | 1 | 1 | 12 |
| | 10-12 | 2-4 | 2 | 2 | 1 | 1 | 1 | 9-11 |
| | 13-14 | 3-4 | 3 | 2 | 1 | 1 | 1 | 11-12 |
| | 15 | 4 | 4 | 2 | 1 | 1 | 1 | 13 |
| | 16-17 | 3-4 | 3 | 3 | 1 | 1 | 1 | 12-13 |
| | 18 | 4 | 4 | 3 | 1 | 1 | 1 | 14 |
| | 19 | 4 | 4 | 4 | 1 | 1 | 1 | 15 |
| | 20-22 | 2-4 | 2 | 2 | 2 | 1 | 1 | 10-12 |
| | 23-24 | 3-4 | 3 | 3 | 2 | 1 | 1 | 13-14 |
| | 25 | 4 | 4 | 4 | 2 | 1 | 1 | 16 |
| | 26-27 | 3-4 | 3 | 3 | 3 | 1 | 1 | 14-15 |
| | 28-30 | 2-4 | 2 | 2 | 2 | 2 | 1 | 11-13 |
| | 31-32 | 3-4 | 3 | 3 | 3 | 2 | 1 | 15-16 |
| | 33 | 3 | 3 | 3 | 3 | 3 | 1 | 16 |
| | 34-36 | 2-4 | 2 | 2 | 2 | 2 | 2 | 12-14 |

TABLE 12

Spatial configuration indices when the number of users is 7 according to an embodiment

| Nᵤₛₑᵣ | Spatial Configuration Index | N_{STS}[1] | N_{STS}[2] | N_{STS}[3] | N_{STS}[4] | N_{STS}[5] | N_{STS}[6] | N_{STS}[7] | Total N_{STS} |
|---|---|---|---|---|---|---|---|---|---|
| 7 | 0-3 | 1-4 | 1 | 1 | 1 | 1 | 1 | 1 | 7-10 |
| | 4-6 | 2-4 | 2 | 1 | 1 | 1 | 1 | 1 | 9-11 |
| | 7-8 | 3-4 | 3 | 1 | 1 | 1 | 1 | 1 | 11-12 |
| | 9 | 4 | 4 | 1 | 1 | 1 | 1 | 1 | 13 |
| | 10-12 | 2-4 | 2 | 2 | 1 | 1 | 1 | 1 | 10-12 |
| | 13-14 | 3-4 | 3 | 2 | 1 | 1 | 1 | 1 | 12-13 |
| | 15 | 4 | 4 | 2 | 1 | 1 | 1 | 1 | 14 |
| | 16-17 | 3-4 | 3 | 3 | 1 | 1 | 1 | 1 | 13-14 |
| | 18 | 4 | 4 | 3 | 1 | 1 | 1 | 1 | 15 |
| | 19 | 4 | 4 | 4 | 1 | 1 | 1 | 1 | 16 |
| | 20-22 | 2-4 | 2 | 2 | 2 | 1 | 1 | 1 | 11-13 |
| | 23-24 | 3-4 | 3 | 3 | 2 | 1 | 1 | 1 | 14-15 |
| | 25-26 | 3-4 | 3 | 3 | 3 | 1 | 1 | 1 | 15-16 |
| | 27-29 | 2-4 | 2 | 2 | 2 | 2 | 1 | 1 | 12-14 |
| | 30 | 3 | 3 | 3 | 3 | 2 | 1 | 1 | 16 |
| | 31-33 | 2-4 | 2 | 2 | 2 | 2 | 2 | 1 | 13-15 |
| | 34-36 | 2-4 | 2 | 2 | 2 | 2 | 2 | 2 | 14-16 |

TABLE 13

Spatial configuration indices when the number of users is 8 according to an embodiment

| Nᵤₛₑᵣ | Spatial Configuration Index | N_{STS}[1] | N_{STS}[2] | N_{STS}[3] | N_{STS}[4] | N_{STS}[5] | N_{STS}[6] | N_{STS}[7] | N_{STS}[8] | Total N_{STS} |
|---|---|---|---|---|---|---|---|---|---|---|
| 8 | 0-3 | 1-4 | 1 | 1 | 1 | 1 | 1 | 1 | 1 | 8-11 |
| | 4-6 | 2-4 | 2 | 1 | 1 | 1 | 1 | 1 | 1 | 10-12 |
| | 7-8 | 3-4 | 3 | 1 | 1 | 1 | 1 | 1 | 1 | 12-13 |
| | 9 | 4 | 4 | 1 | 1 | 1 | 1 | 1 | 1 | 14 |
| | 10-12 | 2-4 | 2 | 2 | 1 | 1 | 1 | 1 | 1 | 11-13 |
| | 13-14 | 3-4 | 3 | 2 | 1 | 1 | 1 | 1 | 1 | 13-14 |
| | 15 | 4 | 4 | 2 | 1 | 1 | 1 | 1 | 1 | 15 |
| | 16-17 | 3-4 | 3 | 3 | 1 | 1 | 1 | 1 | 1 | 14-15 |
| | 18 | 4 | 4 | 3 | 1 | 1 | 1 | 1 | 1 | 16 |
| | 19-21 | 2-4 | 2 | 2 | 2 | 1 | 1 | 1 | 1 | 12-14 |
| | 22-23 | 3-4 | 3 | 3 | 2 | 1 | 1 | 1 | 1 | 15-16 |
| | 24 | 3 | 3 | 3 | 3 | 1 | 1 | 1 | 1 | 16 |
| | 25-27 | 2-4 | 2 | 2 | 2 | 2 | 1 | 1 | 1 | 13-15 |
| | 28-30 | 2-4 | 2 | 2 | 2 | 2 | 2 | 1 | 1 | 14-16 |
| | 31-32 | 2-3 | 2 | 2 | 2 | 2 | 2 | 2 | 1 | 15-16 |
| | 33 | 2 | 2 | 2 | 2 | 2 | 2 | 2 | 2 | 16 |

1. A communication apparatus comprising:
circuitry, which, in operation, generates a physical layer protocol data unit (PPDU) comprising a signal field that indicates resource unit (RU) assignment information for a plurality of other communication apparatuses; and
a transmitter, which, in operation, transmits the PPDU to the plurality of other communication apparatuses in two or more 80 MHz frequency segments;
wherein when one of the plurality of other communication apparatuses parks in one of the two or more 80 MHz frequency segments, RU assignment information corresponding to the one of the plurality of other communication apparatuses is indicated in the signal field transmitted in the one of the two or more 80 MHz frequency segments.

2. The communication apparatus of claim 1, the RU assignment information for the one of the plurality of other communication apparatuses is located outside the one of the two or more 80 MHz frequency segments.

3. The communication apparatus of claim 1, wherein only two or more of the plurality of other communication apparatuses parking in a same 80 MHz frequency segment of the two or more 80 MHz frequency segments are allowed to be multiplexed in a multi-user multiple input and multiple output (MU-MIMO) transmission.

4. The communication apparatus of claim 1, wherein two or more of the plurality of other communication apparatuses parking in different 80 MHz frequency segments of the two or more 80 MHz frequency segments are allowed to be multiplexed in a MU-MIMO transmission if the two or more of the plurality of other communication apparatuses are capable of receiving the MU-MIMO transmission.

5. The communication apparatus of claim 4, wherein when at least one of the two or more of the plurality of other communication apparatuses parks in one 80 MHz frequency segment of the two or more 80 MHz frequency segments, the signal field transmitted in the one 80 MHz frequency segment comprises user fields corresponding to the two or more of the plurality of other communication apparatuses.

6. The communication apparatus of claim 5, wherein each of the user fields, which are not corresponding to the at least one of the two or more of the plurality of other communication apparatuses, is a dummy user field.

7. The communication apparatus of claim 4, wherein at least one of the two or more of the plurality of other communications apparatus parks in one 80 MHz frequency segment of the two or more 80 MHz frequency segments, the signal field transmitted in the one 80 MHz frequency segment comprising one or more user field corresponding to the at least one of the two or more of the plurality of other communications apparatus.

8. The communication apparatus of claim 1, wherein the signal field comprises one or more user field and each of the one of more user field comprises a field to indicate whether the each of the one or more user field is for a MU-MIMO allocation or for a non-MU-MIMO allocation.

9. The communication apparatus of claim 1, wherein the signal field comprises a common field indicating whether a large-size RU or RU combination assignment for a single user is a MU-MIMO allocation or a non-MU-MMO allocation.

10. A communication apparatus comprising:
a receiver, which, in operation, receives a physical layer protocol data unit (PPDU) comprising a signal field that indicates resource unit (RU) assignment information for the communication apparatus transmitted in two or more 80 MHz frequency segments; and
circuitry, which, in operation, processes the PPDU,
wherein when the communication apparatus parks in one of the two or more 80 MHz frequency segments, RU assignment information corresponding to the communication apparatuses is indicated in the signal field transmitted in the one of the two or more 80 MHz frequency segments.

11. The communication apparatus of claim 10, the RU assignment information for the communication apparatus is located outside the one of the two or more 80 MHz frequency segments.

12. The communication apparatus of claim 10, wherein only the communication apparatus and one or more peer communication apparatus parking in a same 80 MHz frequency segment of the two or more 80 MHz frequency segments are allowed to be multiplexed in a multi-user multiple input and multiple output (MU-MIMO) transmission.

13. The communication apparatus of claim 10, wherein the communication apparatus and one or more peer communication apparatus parking in different 80 MHz frequency segments of the two or more 80 MHz frequency segments are allowed to be multiplexed in a MU-MIMO transmission if the communication apparatus and the one or more peer communication apparatuses are capable of receiving the MU-MIMO transmission.

14. The communication apparatus of claim 13, wherein when at least one communication apparatus of the communication apparatus and the one or more peer communication apparatus parks in one 80 MHz frequency segment of the two or more 80 MHz frequency segments, the signal field transmitted in the one 80 MHz frequency segment comprises user fields corresponding to the communication apparatus and the one or more peer communication apparatus.

15. A communication method comprising:
generating a physical layer protocol data unit (PPDU) comprising a signal field that indicates resource unit (RU) assignment information for a plurality of other communication apparatuses; and
transmitting the PPDU to the plurality of other communication apparatuses in two or more 80 MHz frequency segments;
wherein when one of the plurality of other communication apparatuses parks in one of the two or more 80 MHz frequency segments, RU assignment information corresponding to the one of the plurality of other communication apparatuses is indicated in the signal field transmitted in the one of the two or more 80 MHz frequency segments.
